(19) United States
(12) Patent Application Publication
(10) Pub. No.: US 2015/0156362 A1
(43) Pub. Date: Jun. 4, 2015

(54) INPUT DEVICE, IMAGE FORMING APPARATUS, APPLICATION EXECUTING METHOD, CONTROL DEVICE, IMAGE DISPLAY DEVICE AND IMAGE FORMING SYSTEM

(71) Applicant: SHARP KABUSHIKI KAISHA, Osaka-shi, Osaka (JP)

(72) Inventors: Hiroshi Maeda, Osaka-shi (JP); Masaki Tawada, Osaka-shi (JP); Masato Shiozaki, Osaka-shi (JP); Michiaki Nishimura, Osaka-shi (JP)

(73) Assignee: SHARP KABUSHIKI KAISHA, Osaka-shi, Osaka (JP)

(21) Appl. No.: 14/403,940

(22) PCT Filed: Jul. 17, 2013
(86) PCT No.: PCT/JP2013/069412

§ 371 Date: Nov. 25, 2014

(30) Foreign Application Priority Data
Jul. 27, 2012 (JP) 2012-166434
Oct. 9, 2012 (JP) 2012-223813
Dec. 7, 2012 (JP) 2012-268452

(51) Int. Cl. H04N 1/00

(52) U.S. Cl. CPC H04N 1/00891; H04N 1/00411; H04N 1/00904

(57) ABSTRACT

An input device is connected to a display device and an image forming apparatus having an energy saving function. When a prescribed operation instruction suggesting that edition of an image will end soon is received before receiving a print instruction, the input device issues an activation signal causing recovery from an energy saving state to a ready state to the image forming apparatus. Receiving the activation signal, image forming apparatus starts warming-up.

### TECHNICAL FIELD

The present invention relates to an input device, an image forming apparatus, an application executing method, a control device, an image display device and an image forming system. More specifically, the present invention relates to an input device, an image forming apparatus, an application executing method, a control device, an image display device and an image forming system, that transmit an activation signal to the image forming apparatus in an energy saving state (hereinafter also referred to as “power saving state”).

### BACKGROUND ART

Some image forming apparatuses have an energy saving function (hereinafter also referred to as “power saving function”) for controlling power supply to various units forming the apparatus. A state in which only the minimum power is supplied just enough for receiving a user instruction or receiving a facsimile, realized by this function, is referred to as an energy saving state. On the other hand, a state ready to execute a printing process immediately in response to a print instruction is referred to as a ready state. An image forming apparatus having the energy saving function is in the ready state immediately after completing a print process, and after a prescribed time period, the apparatus automatically makes a transition to the energy saving state. If a print instruction is received in the energy saving state, the image forming apparatus re-starts feeding of power to various units to enable execution of a print process. Feeding of power continues until these various units are heated to a prescribed temperature enabling the print process. This state is referred to as a warming-up state. After sufficient power is fed to each unit, the apparatus enters the ready state. In this manner, the state of power conduction in the image forming apparatus having the energy saving function is controlled in accordance with its state of use. Image forming apparatus of this type is used in many companies and offices.

FIG. 8 shows how the state of power conduction changes (recovers) when a print instruction is received while the image forming apparatus in the energy saving state. When the print instruction is received, the image forming apparatus makes a transition from the energy saving state to the warming-up state. After a while of warming-up, when each unit is heated to a prescribed temperature, the image forming apparatus makes a transition to the ready state. Entering the ready state, the image forming apparatus outputs an image in accordance with the received print instruction. In the series of process steps as above, the user is kept waiting, from issuing the print instruction until the print process ends. Therefore, when the apparatus is in the energy saving state, the print process is not immediately executed after the print instruction is received, and the user would be tired of waiting. Particularly if the user is in a hurry to get the print-out and the wait time is long, it could affect business operations.

In offices and companies, it is a common practice to print and hand out minutes of a meeting to participants, at the end of the meeting. Assume that the image forming apparatus is in the power saving state (energy saving state) at the time when the meeting ends, and that a user transmits a print instruction to the image forming apparatus at the end of the meeting. Then, the image forming apparatus must be warmed-up before starting printing. Namely, the time from receiving the print instruction to the completion of printing involves not only the time for printing but for warm-up, while the user is kept waiting until the printing ends. In order to solve this problem, it is desirable to have the image forming apparatus returned earlier to the ready state and to be able to start printing immediately after receiving the print instruction.

In the mean time, recently, as one type of image display apparatuses receiving an instruction input (touch) by a user through a touch-panel, electronic blackboard apparatuses come to be practically used. Electronic blackboard apparatuses are used for conference and the like. An electronic blackboard apparatus most popularly used is configured as a computer system including a combination of an image display apparatus having a large display screen and an input device such as a touch-panel for detecting two-dimensional positional coordinates. Generally, an electronic blackboard apparatus successively reads position coordinates designated by a pen or the like on the display screen, and displays a track of inputs on the display device based on the read pieces of information. Thus, the apparatus can realize functions as an electronic blackboard such as handwritten input.

In order to print an image displayed on an electronic blackboard apparatus as such, sometimes an image forming apparatus is used connected to the electronic blackboard apparatus. If the connected image forming apparatus is of the type having the energy saving function, the same problem as described above arises.

In relation to the problem described above, Patent Literature 1 as listed below discloses a print system in which an image forming apparatus is caused to return from the energy saving state to the ready state when a printer driver is activated. In the print system, when the printer driver is activated, an energy saving mode cancel command, which does not affect printing, is transmitted to the image forming apparatus. Therefore, when the printer driver is activated, the apparatus makes a transition from the energy saving state to the warming-up state at timing earlier than receiving a print instruction. By the time a user instructs printing, the apparatus is already in the warming-up state or the ready state, allowing smooth execution of the print process. Thus, the wait time from the input of print instruction by the user until the print is completed can be made shorter than before.

### CITATION LIST

### Patent Literature

PTL 1: Japanese Patent Laying-Open No. H10-235970

### SUMMARY OF INVENTION

### Technical Problem

If, however, the timing of activation of the printer driver is substantially not different from the timing of input of print instruction by the user and the apparatus is in the warming-up state, again, the user is forced to wait. By way of example, assume that a print instruction is transmitted at the end of a meeting. Here, the timing of activation of the printer driver is almost the same as the timing when the user instructs printing. It is often the case that minutes and materials of meeting are printed at the time when the meeting ends and, therefore, even when the print system disclosed in Patent Literature 1 is used, the user will still be forced to wait. Further, if the warming-up of the apparatus takes time, the user is kept waiting until the print process is completed. Therefore, it is desirable to make shorter the user's wait time when the image forming apparatus is in the energy saving state and printing is required.

In view of the foregoing, an object of the present invention is to provide an image forming apparatus that can make shorter the user's wait time when printing is to be started in the energy saving state.

Another object of the present invention is to provide a control device, an image forming apparatus, and an image forming system enabling reduction of user's wait time until printing is completed, when printing is done using an image forming apparatus that makes a transition to the power saving state.

A further object of the present invention is to provide an image display apparatus and an image forming system enabling effective reduction of user's wait time involved in the recovery of image forming apparatus.

### Solution to Problem

According to a first aspect, the present invention provides an input device, connected to a display device and to an image forming apparatus set in advance to stop power supply to various units forming the image forming apparatus if an instruction to form an image is not received for a prescribed time period. The input device includes input receiving means for receiving an input of an operation instruction to an image displayed on the display device. The operation instruction is a first operation instruction for operating an area including a function icon for editing the image, displayed on the display device, a second operation instruction for operating a prescribed area of the image, or a third operation instruction for switching a page of the image. The input device further includes activation control application executing means, responsive to reception by the input receiving means of any of the first to third operation instructions, for executing an activation control application to transmit, to the image forming apparatus, an activation signal to start power supply to each of the units.

When any one of the first to third operation instructions is received, an activation signal is sent from the input device, and power is fed to various units forming the image forming apparatus. Each of these operation instructions is not an instruction for printing an image but an operation instruction that takes place in an editing stage before printing. Therefore, it becomes possible to start recovery of the image forming apparatus to the ready state before the user is about to start printing. Thus, the user is not kept waiting for a long time until the print process is completed. Further, these operation instructions are common operation instructions made in a general editing operation and, therefore, it is unnecessary for the user to intentionally initiate a special operation.

Preferably, the input device is formed as a touch-panel integrated with the display device.

An image to be printed is displayed on the touch-panel. It is possible for the user to intuitively and easily input using a touch pen or his/her finger while viewing the image.

According to a second aspect, the present invention provides an image forming apparatus set in advance to stop power supply to various units forming the image forming apparatus if an instruction to form an image is not received for a prescribed time period. The image forming apparatus includes a display device, and input receiving means for receiving an input of an operation instruction to an image displayed on the display device. The operation instruction is a first operation instruction for operating an area including a function icon for editing the image, displayed on the display device, a second operation instruction for operating a prescribed area of the image, or a third operation instruction for switching a page of the image. The image forming apparatus further includes activation control application executing means, responsive to reception by the input receiving means of any of the first to third operation instructions, for executing an activation control application to transmit, to the image forming apparatus, an activation signal to start power supply to each of the units.

According to a third aspect, the present invention provides a method of executing an application executed in an input device connected to a display device and to an image forming apparatus set in advance to stop power supply to various units forming the image forming apparatus if an instruction to form an image is not received for a prescribed time period. The input device includes input receiving means for receiving an input of an operation instruction to an image displayed on the display device. The operation instruction is a first operation instruction for operating an area including a function icon for editing the image, displayed on the display device, a second operation instruction for operating a prescribed area of the image, or a third operation instruction for switching a page of the image. The application executing method includes the step of transmitting, in response to reception by the input receiving means of any of the first to third operation instructions, an activation signal to start power supply to each of the units, to the image forming apparatus.

According to a fourth aspect, the present invention provides a control device, connected to an image forming apparatus, for controlling state of power conduction of the image forming apparatus. The image forming apparatus is automatically switched from a normal power conduction state to a power saving state of smaller power consumption if an instruction for forming an image is not received for a prescribed time period, and makes a transition to the normal power conduction state if an activation signal for recovery is received in the power saving state. The image forming apparatus is not capable of forming an image in the power saving state, and at least a certain time period is necessary for the image forming apparatus to recover from the power saving state to the normal power conduction state. The control device includes: schedule management means for managing a schedule of a user; time measuring means for measuring a time; and activation signal transmitting means for transmitting the activation signal to the image forming apparatus, when the time measured by the time measuring means reaches a prescribed time set by the schedule managed by the schedule management means.

When the prescribed time set in the schedule is reached, the control device transmits the activation signal for recovery to the image forming apparatus. When the image forming apparatus is in the power saving state and the activation signal is received, the apparatus goes through a transition period of a certain time or longer and enters the normal power conduction state. Since the activation signal is transmitted automatically, the image forming apparatus starts warming-up when the prescribed time is reached, without necessitating any special operation by the user. By the time the user instructs printing, the image forming apparatus is warming-up or already warmed-up, and hence, printing can be started smooth. Thus, the time from the print instruction until the end of printing can be made shorter than before.

Preferably, the schedule management means manages an end time of a meeting in which the user participates; and the activation signal transmitting means includes means for transmitting the activation signal to the image forming apparatus, when the time measured by the time measuring means reaches a time satisfying a prescribed relation with the end time of the meeting managed by the schedule management means.

If the time that satisfies a prescribed relation with the end time of the meeting set in the schedule is reached, the activation signal is automatically sent to the image forming apparatus. Therefore, the image forming apparatus starts warming-up and makes a transition to the normal power conduction state without necessitating the operation by the user to transmit the activation signal at the end of meeting.

More preferably, the means for transmitting includes means for transmitting the activation signal to the image forming apparatus, when the time measured by the time measuring means reaches a time earlier than the end time of the meeting managed by the schedule management means by a prescribed time period longer than the certain time period.

When the time earlier than the end time of the meeting by a prescribed period longer than the certain time period is reached, the activation signal is automatically sent to the image forming apparatus. Therefore, by the time the meeting ends, the image forming apparatus is warming-up or already warmed-up, and hence, printing can be started smooth. If the certain time period is set to correspond to the time period necessary for warming up the image forming apparatus, it becomes possible to have the image forming apparatus surely in the normal power conduction state at the end time of the meeting.

Preferably, the activation signal transmitting means includes means for starting a process for repeatedly transmitting the activation signal to the image forming apparatus at a constant interval, when the time measured by the time measuring means reaches a time satisfying a prescribed relation with the end time of the meeting managed by the schedule management means.

If the time that satisfies a prescribed relation with the end time of the meeting set in the schedule is reached, the control device repeatedly transmits the activation signal to the image forming apparatus at a constant time interval. As the activation signal is repeatedly transmitted a short while before the end of meeting, the image forming apparatus is kept in the normal power conduction state for a prescribed time period, and printing can immediately be executed in response to reception of a print instruction. Therefore, if the meeting fails to end on time actually, the image forming apparatus can start execution of printing immediately in response to reception of a print instruction.

Preferably, the schedule management means includes schedule collective management means for collectively managing schedules of a plurality of users; and the activation signal transmitting means includes means for transmitting the activation signal to the image forming apparatus, when the time measured by the time measuring means reaches a prescribed time set by a schedule managed by the schedule collective management means.

The control device collectively manages schedules of a plurality of users, and when a prescribed time set in the schedules is reached, it transmits the activation signal to the image forming apparatus. Therefore, if each user registers his/her schedule, individual schedules are collectively controlled, and the activation signal is transmitted at a prescribed time set in the collective schedules. Since the prescribed time can be set without necessitating individual setting by each user, the time and labor for the user to set the schedule can be saved.

According to a fifth aspect, the present invention provides an image forming system including an image forming apparatus and a control device connected to the image forming apparatus and controlling state of power conduction of the image forming apparatus. The image forming apparatus is automatically switched from a normal power conduction state to a power saving state of smaller power consumption if an instruction for forming an image is not received for a prescribed time period, and makes a transition to the normal power conduction state if an activation signal for recovery is received in the power saving state. Further, the image forming apparatus is not capable of forming an image in the power saving state, and at least a certain time period is necessary for the image forming apparatus to recover from the power saving state to the normal power conduction state. The control device includes schedule management means for managing a schedule of a user, time measuring means for measuring a time, and activation signal transmitting means for transmitting the activation signal to the image forming apparatus, when the time measured by the time measuring means reaches a prescribed time set by the schedule managed by the schedule management means.

According to the sixth aspect, the image forming apparatus is automatically switched from a normal power conduction state to a power saving state of smaller power consumption if an instruction for forming an image is not received for a prescribed time period, and makes a transition to the normal power conduction state if an activation signal for recovery is received in the power saving state, the image forming apparatus is not capable of forming an image in the power saving state, and at least a certain time period is necessary for the image forming apparatus to recover from the power saving state to the normal power conduction state. The image forming apparatus includes schedule collective management means for collectively managing schedules of a plurality of users transmitted from a connected external device, time measuring means for measuring a time, and activation signal transmitting means, responsive to the time measured by the time measuring means reaching a prescribed time set in the schedule managed by the schedule collective management means, for transmitting an activation signal to various functional units forming the image forming apparatus.

According to a seventh aspect, the present invention provides a control device connected to an image forming apparatus, used in a room where a meeting is held. The image forming apparatus is automatically switched from a normal power conduction state to a power saving state of smaller power consumption if an instruction for forming an image is not received for a prescribed time period, and makes a transition to the normal power conduction state if an activation signal for recovery is received in the power saving state. Further, the image forming apparatus is not capable of forming an image in the power saving state, and at least a certain time period is necessary for the image forming apparatus to recover from the power saving state to the normal power conduction state. The control device includes analyzing means for analyzing data related to an environment around the control device, and activation signal transmitting means responsive to a result of analysis by the analyzing means satisfying a prescribed condition, for transmitting an activation signal to the image forming apparatus.

If the data related to the environment around the control device satisfies a prescribed condition, the activation signal is automatically transmitted to the image forming apparatus. Therefore, if the prescribed condition is set in advance, the image forming apparatus starts warming-up without necessitating any special operation by the user.

Preferably, the analyzing means includes image analyzing means for detecting the number of moving objects therearound by analyzing image data obtained by picking up images around the control device, and the activation signal transmitting means includes means, responsive to the number of objects analyzed by the image analyzing means being equal to or larger than a prescribed number, for transmitting the activation signal to the image forming apparatus.

When moving objects of a prescribed number or more are detected from the image data obtained by picking up the image around the control device, the activation signal is transmitted to the image forming apparatus. The conference room of the meeting in which the user participates is video-recorded, and when a prescribed number or more of the participants stand up, the activation signal is automatically transmitted to the image forming apparatus. Therefore, the control device detects the end of meeting and transmits the activation signal to the image forming apparatus without necessitating any special operation by the user. Since the image forming apparatus starts transition to the normal power conduction state in response to the activation signal, printing can be started smooth in response to the print instruction by the user.

Preferably, the analyzing means includes voice analyzing means for measuring voice volume by analyzing voice data obtained by recording voice around the control device, and the activation signal transmitting means includes means, responsive to measurement by the voice analyzing means of voice volume being equal to or higher than a prescribed value, for transmitting the activation signal to the image forming apparatus.

When voice volume equal to or higher than a prescribed value is detected from the voice data obtained by recording the voice around the control device, the activating signal is automatically transmitted to the image forming apparatus. The voice of meeting in which the user participates is recorded and, if the voices of chats among participants started after the end of meeting are detected to be louder than the prescribed value, the activation signal is automatically transmitted to the image forming apparatus. Therefore, the control device detects the end of meeting and transmits the activation signal to the image forming apparatus without necessitating any special operation by the user.

Preferably, the analyzing means includes voice analyzing means for analyzing voice data obtained by recording voices around the control device and for detecting the number of voice sources, and the activation signal transmitting means includes means, responsive to detection by the voice analyzing means of different voice sources equal to or larger than a prescribed number, for transmitting the activation signal to the image forming apparatus.

When different voice sources of a prescribed number or larger is detected from the voice data obtained by recording the voices around the control device, the activation signal is automatically transmitted to the image forming apparatus. When a meeting ends and the participants start chatting, it is detected that there are voice sources of a prescribed number or larger, and the activation signal is automatically transmitted to the image forming apparatus. Therefore, the control device detects the end of meeting and transmits the activation signal to the image forming apparatus without necessitating any special operation by the user.

According to an eighth aspect, the present invention provides an image forming system including an image forming apparatus and a control device connected to the image forming apparatus and used in a room where a meeting is held. The image forming apparatus is automatically switched from a normal power conduction state to a power saving state of smaller power consumption if an instruction for forming an image is not received for a prescribed time period, and makes a transition to the normal power conduction state if an activation signal for recovery is received in the power saving state. Further, the image forming apparatus is not capable of forming an image in the power saving state, and at least a certain time period is necessary for the image forming apparatus to recover from the power saving state to the normal power conduction state. The control device includes analyzing means for analyzing data related to an environment around the control device, and activation signal transmitting means, responsive to a result of analysis provided by the analyzing means satisfying a prescribed condition, for transmitting the activation signal to the image forming apparatus.

According to a ninth aspect, the present invention provides an image display device connected to an image forming apparatus capable of switching operations between a normal power conduction state and an energy saving state with reduced power consumption. The image display device includes: display operation means for receiving a touch operation and displaying an image; activation signal transmitting means, responsive to the display operation means receiving a prescribed marking operation as the touch operation, for transmitting an activation signal for switching the image forming apparatus from the energy saving state to the normal power conduction state, to the image forming apparatus; and image data transmitting means for transmitting image data of an image displayed on the display operation means to the image forming apparatus.

The image display device displays an image upon reception of a touch operation by the user. The image display device further transmits the activation signal to the image forming apparatus, in response to the display operation means receiving a prescribed marking operation as a touch operation. Receiving the activation signal from the image display device, the image forming apparatus starts recovery to the normal power conduction state. This enables easy recovery of the image forming apparatus. Further, when the image displayed on the image display apparatus is to be printed by the image forming apparatus, it is possible to start recovery of the image forming apparatus in advance, before sending the image data to the image forming apparatus. Thus, the time from transmission of the image data to printing can effectively be reduced.

Here, if the prescribed marking operation is done at timing considering the time necessary for the recovery from the energy saving state to the normal power conduction state, it is possible to have the image forming apparatus returned to the normal power conduction state by the time the image data is transmitted. Thus, the wait time of the user in connection with the recovery of the image forming apparatus can more effectively be reduced.

Assume, for example, that the image display device is used for a meeting. Then, it is preferred to use an operation (action) commonly done before the end of meeting as the prescribed marking operation. By such an approach, it becomes possible to transmit the activation signal to the image forming apparatus without necessitating any special operation. Specifically, it is possible to predict start of printing based on a common use of the image display device, and to transmit the activation signal to the image forming apparatus in advance. By this approach, it follows that the image forming apparatus is already returned to the normal power conduction state when the meeting ends and, therefore, printing by the image forming apparatus can be started immediately after the end of meeting.

Preferably, the image display device further includes means for displaying an icon for pasting a drawn image of a prescribed shape on the display operation means; the display operation means includes means for receiving a marking operation of touching the icon and for displaying an image corresponding to the icon; and the activation signal transmitting means includes means, responsive to the display operation means receiving the operation of touching the icon, for transmitting the activation signal for switching the image forming apparatus from the energy saving state to the normal power conduction state, to the image forming apparatus.

The image display device receives a touch operation of an icon and displays an image corresponding to the icon. Further, in response to the display operation means receiving the touch operation of the icon, the image display device transmits the activation signal to the image forming apparatus. Whether an icon is touch-operated or not can easily be detected and, therefore, detection is not troublesome. Thus, the activation signal can quickly be transmitted. Therefore, the wait time of the user related to the recovery of image forming apparatus can easily and effectively be reduced.

More preferably, the touch operation is a drawing operation for displaying a drawn image. The image display device further includes detecting means for detecting, based on a difference between image data before and after the drawn image is displayed, whether the drawn image has a prescribed shape. The activation signal transmitting means includes means, responsive to the display operation means receiving, as the prescribed marking operation, an operation of drawing an image having the prescribed shape, based on a result of detection by the detecting means, for transmitting the activation signal for switching the image forming apparatus from the energy saving state to the normal power conduction state, to the image forming apparatus.

The image display device receives a drawing operation by the user and displays the drawn image. If the drawn image drawn by the drawing operation is an image of a prescribed shape, the image display device transmits the activation signal to the image forming apparatus. In this manner, by drawing a prescribed image, it is possible to transmit the activation signal to the image forming apparatus and, therefore, no special operation by the user is necessary. This is more convenient for the user.

According to a tenth aspect, the present invention provides an image display device connected to an image forming apparatus capable of switching operations between a normal power conduction state and an energy saving state with reduced power consumption. The image display device includes: display means for displaying an image; voice recognizing means for recognizing a voice around the image display device while the display means is displaying an image; time measuring means for measuring a time period in which no voice is recognized by the voice recognizing means; activation signal transmitting means for transmitting an activation signal for switching the image forming apparatus from the energy saving state to the normal power conduction state to the image forming apparatus, when a prescribed time period passed without recognizing any voice; and image data transmitting means for transmitting image data of the image displayed on the display means to the image forming apparatus.

Assuming that the image display device is used for a meeting, it is often the case that the number of remarks and comments decreases near the end of meeting. In response to the lapse of a prescribed time period without recognizing any voice, the image display device transmits the activation signal to the image forming apparatus. Thus, it is possible to predict end of the meeting and to transmit the activation signal to the image forming apparatus in advance. Since the image forming apparatus is already returned to the normal power conduction state when the meeting ends, printing by the image forming apparatus can be started immediately after the end of meeting.

According to an eleventh aspect, the present invention provides an image forming system including an image forming apparatus capable of switching operations between a normal power conduction state and an energy saving state with reduced power consumption, and an image display device connected to the image forming apparatus. In the image forming system, the image display device includes display operation means for receiving a touch operation and displaying an image, activation signal transmitting means, responsive to the display operation means receiving a prescribed marking operation as the touch operation, for transmitting an activation signal for switching the image forming apparatus from the energy saving state to the normal power conduction state, to the image forming apparatus, and image data transmitting means for transmitting image data of an image displayed on the display operation means to the image forming apparatus. The image forming apparatus includes means for receiving the activation signal transmitted from the activation signal transmitting means and switching its operation to the energy saving state, and means for receiving the image data transmitted from the image data transmitting means and for forming an image based on the image data.

The image display device receives a touch operation by the user and displays an image. Further, in response to the display operation means receiving a prescribed marking operation as a touch operation, the image display device transmits the activation signal to the image forming apparatus. Receiving the activation signal, the image forming apparatus starts recovery to the normal power conduction state. This enables easy recovery of the image forming apparatus. Further, when the image displayed on the image display apparatus is to be printed by the image forming apparatus, it is possible to start recovery of the image forming apparatus in advance, before sending the image data to the image forming apparatus. Thus, the time from transmission of the image data to printing can effectively be reduced.

### Advantageous Effects of Invention

As described above, by the present invention, when a display is given on the display device and any of the first to third operation instructions is given, the activation signal is transmitted to the image forming apparatus, and power supply to various units starts. These operation instructions are all operation instructions issued in the state of editing images before printing. Therefore, it follows that the image forming apparatus returns to the ready state before receiving a print instruction of the image, and hence, it can return to the ready state earlier than in the conventional approach. As a result, when printing is to be done from the energy saving state, the wait time of the user can be made shorter.

Further, by the present invention, when the image forming apparatus that is switched to the power saving state is used for printing, the activation signal is automatically transmitted to the image forming apparatus when an event indicating the end of a meeting is detected. Therefore, the wait time of the user before the completion of printing can be reduced compared with the conventional approach.

Further, by the present invention, an image display device and an image forming system that can effectively reduce the wait time of the user related to the recovery of image forming apparatus can readily be realized.

### BRIEF DESCRIPTION OF DRAWINGS

FIG. 1 is a schematic illustration showing a print system in accordance with a first embodiment of the present invention.

FIG. 2 shows an electric configuration of the print system shown in FIG. 1.

FIG. 3 is a flowchart representing a control structure of a computer program executed when any operation is done on the displayed image.

FIG. 4 illustrates a method of changing and operating an image display.

FIG. 5 illustrates a method of changing and operating an image display.

FIG. 6 illustrates a change of the image display.

FIG. 7 shows an electric configuration of the image forming apparatus in accordance with the first embodiment of the present invention.

FIG. 8 illustrates transitions among states of power conduction in a conventional image forming apparatus.

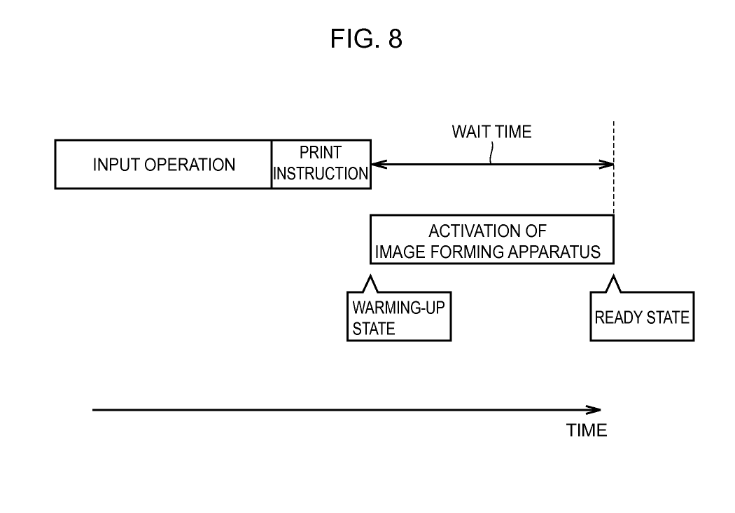

FIG. 9 illustrates transitions among states of power conduction in an image forming apparatus in accordance with the first embodiment of the present invention.

FIG. 10 shows an overall configuration of an image forming system in accordance with a second embodiment of the present invention.

FIG. 11 is a control block diagram showing a hardware configuration of each of the apparatuses and devices forming the image forming system shown in FIG. 10.

FIG. 12 is a transition diagram illustrating an operation of the image forming system in accordance with the second embodiment of the present invention.

FIG. 13 shows an appearance of an image display device in accordance with a third embodiment of the present invention.

FIG. 14 is a control block diagram showing a hardware configuration of each of the apparatuses and devices forming the image forming system in accordance with the third embodiment of the present invention.

FIG. 15 is a transition diagram illustrating an operation of the image forming system in accordance with the third embodiment of the present invention.

FIG. 16 shows an overall configuration of an image forming system in accordance with a fourth embodiment of the present invention.

FIG. 17 is a schematic illustration of the electronic blackboard apparatus of FIG. 16 (showing an example of screen image displayed on the display device).

FIG. 18 is a control block diagram showing a hardware configuration of the electronic blackboard apparatus shown in FIG. 16.

FIG. 19 is a control block diagram showing a hardware configuration of the image forming apparatus shown in FIG. 16.

FIG. 20 is a flowchart representing a control structure of a program executed by the electronic blackboard apparatus shown in FIG. 16.

FIG. 21 is a transition diagram illustrating an operation of an image forming system in accordance with the fourth embodiment of the present invention.

FIG. 22 is a control block diagram showing a hardware configuration of the electronic blackboard apparatus in accordance with a sixth embodiment of the present invention.

FIG. 23 is a schematic illustration of the electronic blackboard apparatus in accordance with the sixth embodiment of the present invention.

FIG. 24 is a flowchart representing a control structure of a program executed by the electronic blackboard apparatus in accordance with the sixth embodiment of the present invention.

FIG. 25 is a control block diagram showing a hardware configuration of an electronic blackboard apparatus in accordance with a seventh embodiment of the present invention.

### DESCRIPTION OF EMBODIMENTS

In the following description and in the drawings, the same components are denoted by the same reference characters. Therefore, detailed description thereof will not be repeated.

### First Embodiment

### State Transition of Image Forming Apparatus

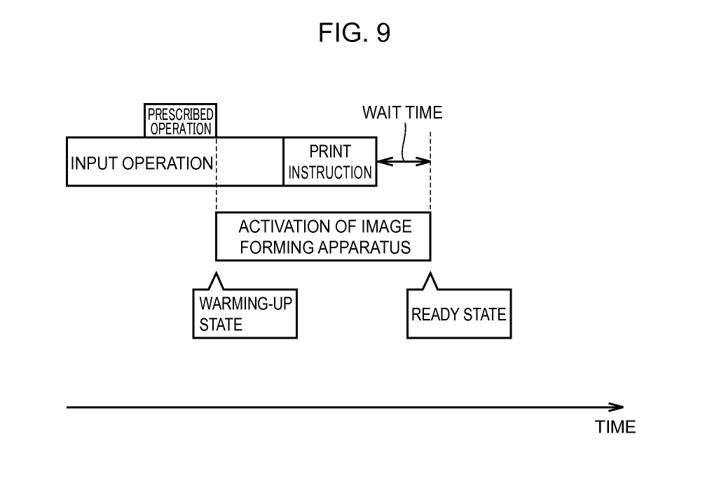

In the present embodiment, the image forming apparatus makes a transition from the energy saving state to the warming-up state before receiving a print instruction. Referring to FIG. 9, while the image forming apparatus is in the energy saving state, when a user makes a prescribed operation, in response, the image forming apparatus starts power supply to various units and enters the warming-up state. What the prescribed operation is will be described later. When sufficient power is supplied to the units, the image forming apparatus enters the ready state. In this manner, before the user gives an output instruction, the image forming apparatus makes a transition from the energy saving state to the warming-up state and, therefore, as compared with the wait time experienced in the conventional apparatus, the wait time becomes shorter, as can be seen from FIG. 9.

[Outline of Print System]

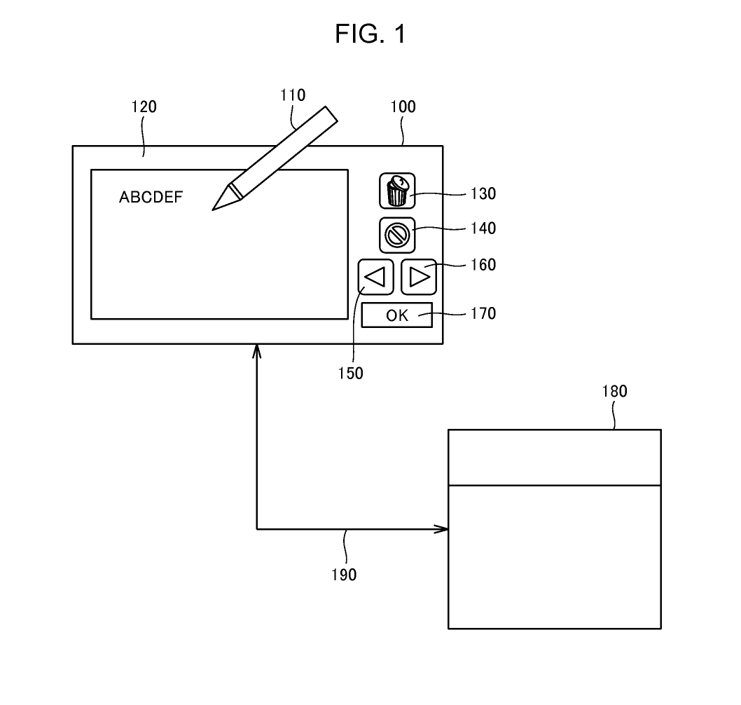

Referring to FIG. 1, the print system in accordance with the present embodiment includes an input device 100 and an image forming apparatus 180. These are connected through a LAN (Local Area Network) environment 190, and it is possible for a user to instruct printing to image forming apparatus 180 by operating input device 100.

In the present embodiment, input device 100 includes a touch-panel display 120 (hereinafter also simply referred to as a display 120) having a display function and an input detecting function. An image is displayed on display 120, and the user can make an operation on the image using a touch pen 110. When the user operates touch pen 110 and thereby makes an operation such as touching the displayed image, input device 100 detects at which position on the display the operation took place, and an input in accordance with the operation is executed on the displayed image. Specifically, by an operation with a touch pen, an input to the displayed image can be done by the user in a similar manner with a similar feeling as writing on a sheet of paper with a pen or a pencil.

On touch-panel display 120, an erase icon 130, an input lock icon 140 for invalidating any input to the image, a previous-page icon 150 for returning the image displayed on the display to the previous page, a next-page icon 160 for feeding to the next page, and a print icon 170 instructing printing of the image displayed on the display can be displayed. The manner how these icons are displayed will be described later. In the following description, previous-page icon 150 and next-page icon 160 will be sometimes collectively referred to as a page switching icon.

[Hardware Configuration]

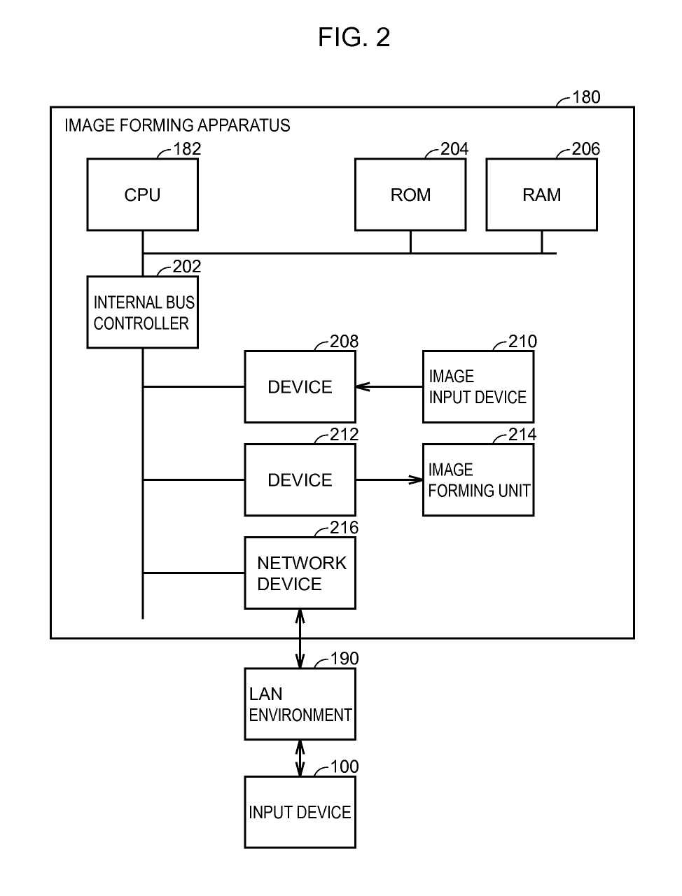

Referring to FIG. 2, input device 100 and image forming apparatus 180 are connected to each other through LAN environment 190. Image forming apparatus 180 includes a CPU (Central Processing Unit) 182 for controlling each of the functional units and components, an internal bus controller 202 for controlling an internal bus connecting the CPU to each of the various units, an ROM (Read-Only Memory) 204 connected to the internal bus and storing an application, and an RAM (Random Access Memory) 206 also connected to the internal bus for storing image data of the image to be printed. The user selects an image from image data saved in RAM 206, and causes display 120 (see FIG. 1) of input device 100 to display the image. When there is any new input to the image data, an image reflecting the input is saved in RAM 206.

Image forming apparatus 180 further includes an image input device 210 for scan-in of an image, a device 208 connected to an internal bus, for controlling image input device 210, an image forming unit 214 for forming an image on a recording medium, a device 212 connected to the internal bus for controlling the image forming unit 214, and a network device 216 connected to the internal bus, for connecting image forming apparatus 180 and LAN environment 190.

Input device 100 includes a CPU, not shown. When a user instructs printing of an image displayed on the display by operating touch-panel display 120, a signal causing image forming apparatus 180 to execute printing is transmitted from the CPU.

[Software Configuration]

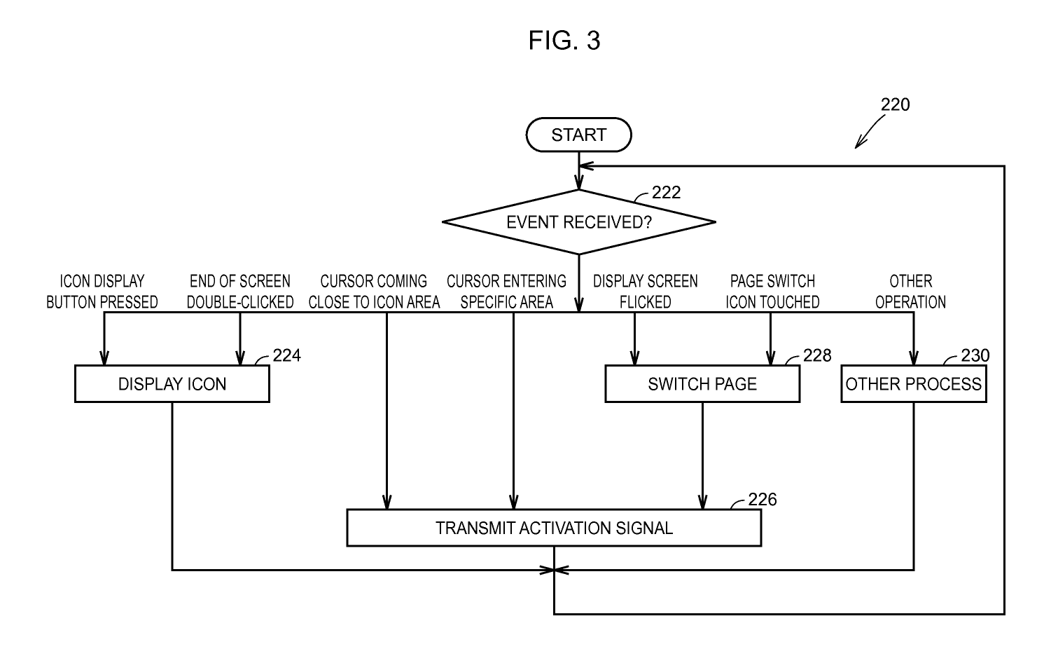

Referring to FIG. 3, a program 220 executed by the CPU of input device 100 to realize input device 100 in accordance with the present embodiment is started in response to display of an image on display 120. The image is stored in RAM 206 of image forming apparatus 180, and when the user selects the image from selection images (not shown), the image is displayed on the display.

Program 220 includes a step 222 of receiving an event generated in accordance with which position on the display is operated in what manner, and determining the type of the event. In accordance with the result of determination, the control structure branches as shown in FIG. 3.

Program 220 includes a step 224 of displaying various icons on display 120 in response to pressing of an icon display button (not shown) provided on touch pen 110, or in response to a double-click of an end portion of display screen of display 120.

Program 220 includes a step 226 of transmitting an activation signal causing image forming apparatus 180 to cause power supply to various units, in response to a cursor, operated by the user, coming close to an area where the icons are displayed on display 120, or in response to the cursor entering a specific area on display 120. The scope of the end portion of display screen, the area near the icons and the specific area can appropriately be set by the user.

Program 220 includes a step 228 of switching the page image displayed on the display to the previous page or the next page, in response to a flick operation on display 120 or in response to a touch to the page switch icon.

Program 220 includes a step 230 of executing, in response to detection of an operation other than those described above, a prescribed process in accordance with the operation.

When the process of steps 224 to 230 ends, the control returns to step 222 and waits for the next event.

[Operation]

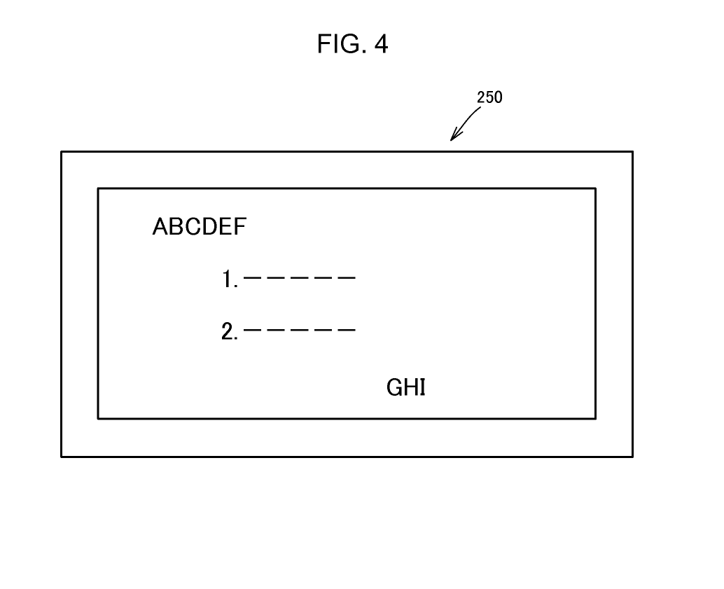

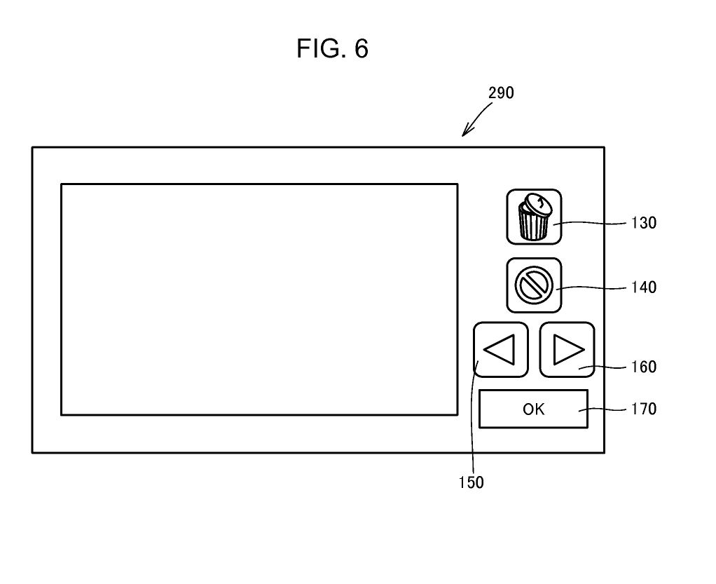

Referring to FIGS. 3 to 6, when an image is displayed on display 120, the CPU waits for an event (step 222). In accordance with the detected event, the CPU operates in the following manner.

When the user presses an icon display button, or double-clicks an end portion of display 120, the CPU displays various icons on display 120.

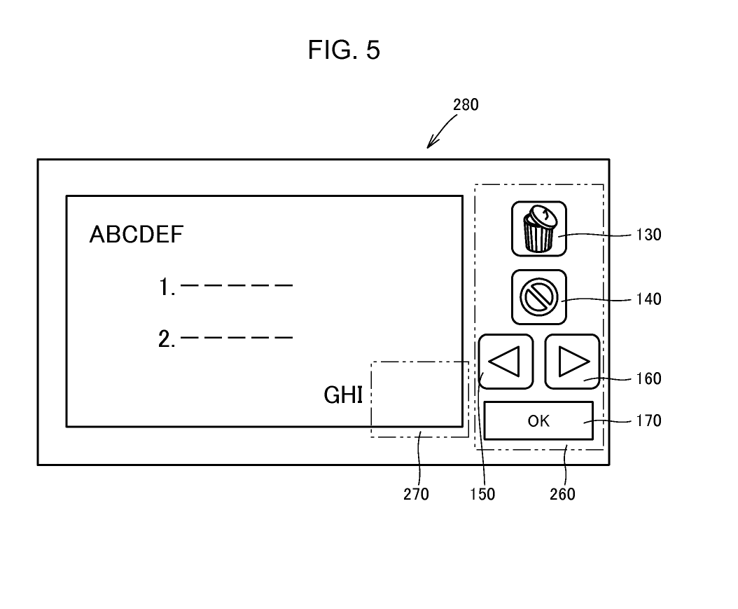

When the user moves a cursor displayed on the display using touch pen 110 to the area 260 near the icons or to the specific area 270 shown in FIG. 5, the CPU transmits the activation signal, instructing power supply to various units forming image forming apparatus 180, to image forming apparatus 180. Here, if image forming apparatus 180 is in the energy saving state, image forming apparatus 180 starts warming-up in response to the reception of activation signal. The specific area is an area including a lower right portion of the image, which is assumed to be edited last when the user edits the image. As mentioned above, the scope of specific area 270 can appropriately be set by the user.

When the user flicks display 120, the image displayed on the display is switched to the previous page or the next page. Whether it is switched to the previous or next page is determined by the flick direction. By way of example, assume that an input operation of a certain page ends and the display is to be changed to the next, new page. Then, the user flicks touch pen 110 from right to left on display screen image 280 on which input operation has been done, and the display changes from the screen image 280 to a display screen image 290, on which input operation is not yet done. If confirmation of inputs to the previous page is desired, the user flicks touch pen 110 from left to right on display screen image, and the image of previous page is displayed on the display. The same results can be attained when the user touches the page switch icon. Namely, if previous-page icon 150 is touched, the image of previous page is displayed, and if next-page icon 160 is touched, the image of next page is displayed.

When an operation other than those described above is done by the user, a prescribed process in accordance with the detected event is executed.

[Functions and Effects]

As described above, by input device 100 in accordance with the first embodiment, if an operation of moving the cursor to the area 260 near icons or to the specific area 270 is done, the image forming apparatus that is in the energy saving state can be warmed-up. These operations are both commonly done before the image is printed, at the last stage of image edition. Therefore, the image forming apparatus starts warming-up before receiving the print instruction, without necessitating any special operation by the user. As a result, the time from reception of print instruction until the end of printing can be made shorter, and the wait time of the user for the print process can be reduced.

### Modification of First Embodiment

The print system in accordance with the first embodiment described above is implemented by an input device and an image forming apparatus. A configuration in which the series of operations is completed only in the image forming apparatus is also possible. Further, in the embodiment described above, when image forming apparatus 180 is in the energy saving state, power is supplied only to the functional unit for receiving the operation instructions. It is possible, however, to supply power to various functional units except for the image forming unit when the image forming apparatus is in the energy saving state. An image forming apparatus 300 described in the following has such a configuration.

[Hardware Configuration]

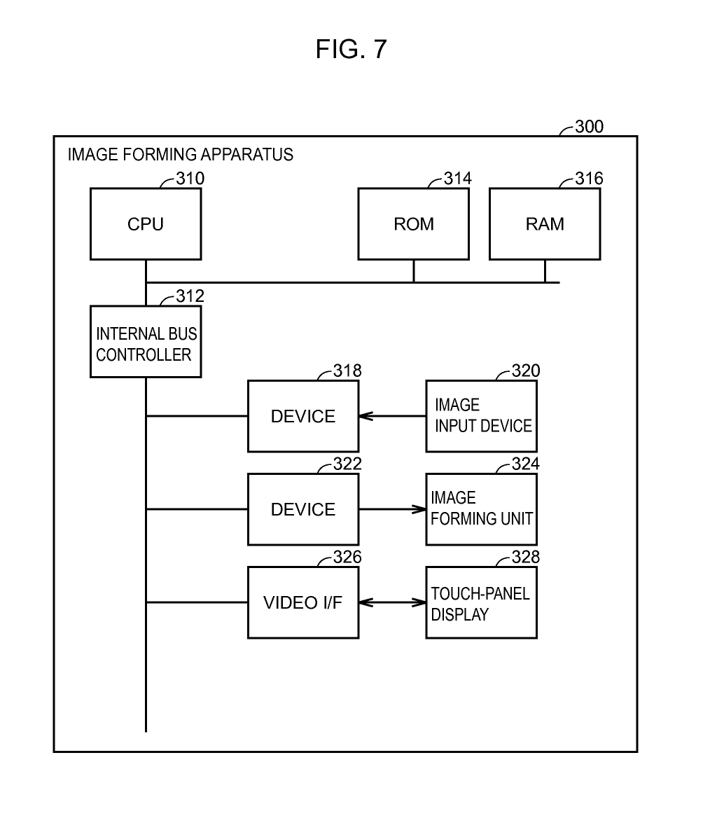

Referring to FIG. 7, of the various functional units forming image forming apparatus 300 in accordance with the present embodiment, CPU 310, internal bus controller 312, ROM 314, RAM 316, device 318, image input device 320 and touch-panel display 328 have the same functions as those of the first embodiment. In addition to these units, image forming apparatus 300 includes an image forming unit 324 for forming an image on a recording medium, a device 322 connected to an internal bus for controlling image forming unit 324, and a video interface (hereinafter denoted as video I/F) 326, connected to the internal bus for displaying an image on display 328. CPU 310 has functions of both CPU 182 and the CPU provided in input device 100.

[Operation]

Referring to FIGS. 3 and 7, image forming apparatus 300 in accordance with the present embodiment operates in the following manner. The operations of image forming apparatus 300 other than those described in the following are the same as those of input device 100 described above.

Referring to FIG. 3, at step 226, CPU 310 transmits the activation signal causing image forming apparatus 300 to start warming-up, to image forming unit 324. When image forming apparatus 300 is in the energy saving state, in response to reception of the activation signal, power supply to the image forming unit 324 starts.

[Functions and Effects]

The effects similar to those attained by the first embodiment above can also be attained by image forming apparatus 300 in accordance with the modification. Further, even in the energy saving state, image forming apparatus 300 is capable of operations such as image reading and editing and, therefore, power consumption for image edition can be reduced as compared with a conventional image forming apparatus.

In the embodiment above, input to an image is done by using a touch pen 110. Other method of input is also possible. By way of example, a part of one's body, such as a finger, may be used in place of the touch pen, or a keyboard or a mouse may be used for input. Further, input operation by voice may also be possible.

In the embodiment above, the image to be printed is stored in the RAM in advance. The image to be printed, however, is not limited thereto. By way of example, an image scanned and input by image input device 210 or 320 may be displayed on the display and the operation shown in FIG. 3 may be done on the image. Alternatively, an image transferred from another terminal through an e-mail may be displayed on the display, and the similar operation may be done on the image. Alternatively, an external storage may be connected to the apparatus, and the image stored in the storage may be displayed on the display.

In the embodiment above, erase icon 130, input lock icon 140, previous-page icon 150, next-page icon 160 and print icon 170 are displayed on the display. The displayed icons, however, are not limited to the above. In addition to these icons, icons representing image editing functions and icons indicating image print settings may be displayed. Further, the operation for displaying various icons is not limited to the operation of pressing the icon display button and the double-click of an end portion of the screen image described above. For example, icons may be displayed in semi-transparent manner over the image, and the icon display may be made vivid when the user touches the portion where the icon is displayed.

In the embodiment above, the area 260 near the icons includes all icons described above, as shown in FIG. 5. The scope of the area may be set to include only a prescribed icon or icons. By way of example, if a user often performs print settings before printing an image, an area including the above-described icons and an icon for print setting may be set as the area near the icons, and the image forming apparatus may be adapted not to make the transition to the ready state if the user operates any other icon or near other icons. Further, though the specific area 270 is at the lower right portion of the screen in the embodiment above, the scope of the area is not limited thereto. The lower part of the screen as a whole, or an area indicating page number may be set as the specific area.

In the embodiment above, when an operation of operating the area near the icons, an operation of the specific area, or the operation of switching a page causes transmission of the activation signal to the image forming apparatus. The operation serving as a trigger of transmitting the activation signal, however, is not limited to these operations. Any operation generally done immediately before printing, such as an operation of displaying an image preview and the like, may be set as an operation as a trigger to transmit the activation signal.

### Second Embodiment

### Overall System Configuration

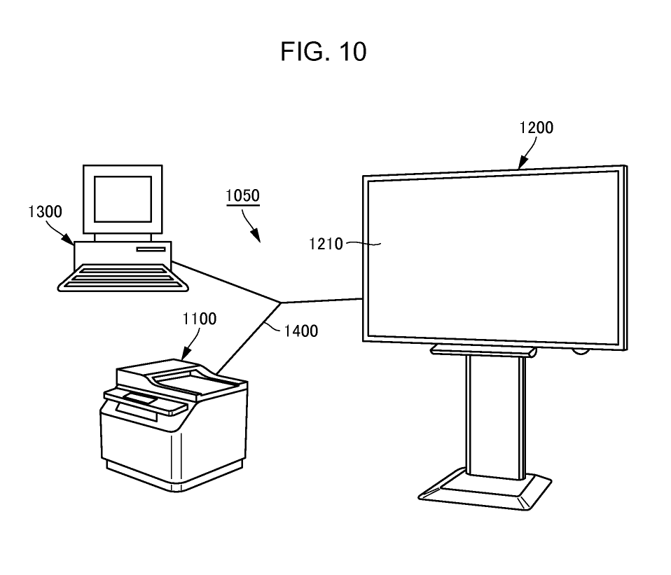

Referring to FIG. 10, an image forming system 1050 in accordance with the present embodiment includes an image forming apparatus 1100, an image display device 1200 and an information processing apparatus 1300. These are connected by a network 1400, and transmit/receive signals between each other.

Image forming apparatus 1100 is a multifunctional peripheral having, for example, copy, printer and facsimile functions. Image forming apparatus 1100 has a so-called laser type (electrophotographic) printing function using a laser beam for exposure. The apparatus, however, may have a different type printing function.

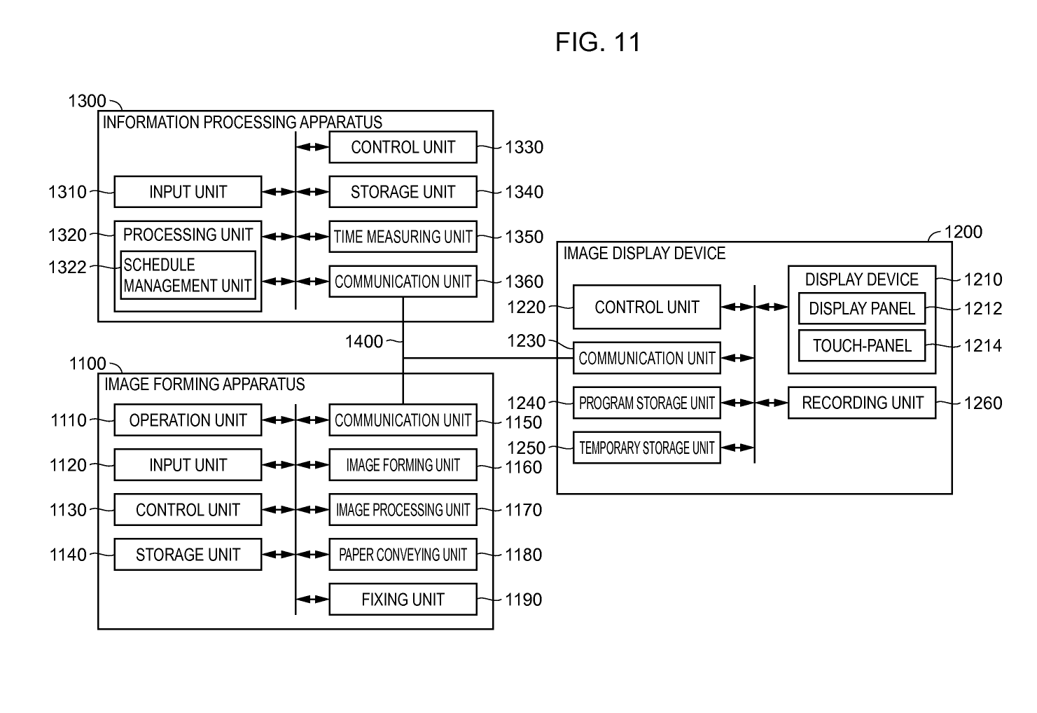

Image forming apparatus 1100 has a normal mode, which corresponds to the ready state, and a power saving mode, which corresponds to the power saving state. If a print instruction (print job) is received in the normal mode, image forming apparatus 1100 immediately executes printing. When a prescribed time period passes without an instruction of printing or other operation, image forming apparatus 1100 makes a transition from the normal mode to the power saving mode for reducing power consumption. In the power saving mode, in order to reduce power consumption, electric power is supplied only to portions necessary for data reception. In the power saving mode, power supply to a fixing unit 1190 (see FIG. 11) for image formation is also reduced. Therefore, in the power saving mode, image forming apparatus 1100 cannot immediately execute any process if a print instruction or the like is received, and warming-up is necessary to enter the normal mode. Generally, when image data transmitted from an external device such as a personal computer or a facsimile is received in the power saving mode, image forming apparatus 1100 starts recovery to the normal mode. After a prescribed time period from the recovery to the normal mode, image forming apparatus 1100 again makes a transition to the power saving mode.

In the present embodiment, it is assumed that image forming system 1050 is used, for example, for a meeting. In image forming system 1050, information processing apparatus 1300 manages user's schedule. The schedule contains start time and end time of a meeting in which the user attends, as well as information of the place of meeting. Further, images and the like displayed on image display device 1200 can be printed by image forming apparatus 1100. If image forming apparatus 1100 does not receive any instruction such as a print instruction for a prescribed time period or longer during the meeting, image forming apparatus 1100 makes a transition from the normal mode to the power saving mode.

[Hardware Configuration]

<<Image Forming Apparatus 1100>>

Referring to FIG. 11, the devices and apparatuses forming image forming system 1050 have the following structures. Image forming apparatus 1100 includes: an operation unit 1110 allowing a user to operate image forming apparatus 1100; an input unit 1120 for receiving an instruction input based on the user operation; a control unit 1130 for controlling various functional units; a storage unit 1140 for storing image data read by an image reading unit, not shown, and various programs activated in image forming apparatus 1100; and a communication unit 1150 for transmitting/receiving signals between image forming apparatus 1100 and an external device connected thereto. Operation unit 1110 is an operation panel (not shown) including a touch-panel display and various buttons, and the user can instruct printing and other processes by operating operation keys displayed on the touch-panel display and the buttons.

Image forming apparatus 1100 further includes: an image forming unit 1160 for forming an image on a recording medium (recording paper); an image processing unit 1170 for editing image data read by a document reading unit, not shown; a paper conveying unit 1180 for conveying the recording paper; and a fixing unit 1190 for fixing the image formed by image forming unit 1160 on the recording paper.

In image forming apparatus 1100, various image processing operations are done by image processing unit 1170 on the image data received from a connected external device, and the resulting image data is output to image forming unit 1160. Image forming unit 1160 includes, for example, a photoreceptor drum, a charger, a laser scan unit, a developer, a transfer device, a cleaning device, and an eraser device. A feeding path is provided in paper conveying unit 1180, and a sheet of recording paper fed from a paper feed unit, not shown, is conveyed along the feeding path. The paper feed unit draws out sheets of recording paper held in a paper cassette or placed on a manual feed tray one by one and feeds to the feeding path of paper conveying unit 1180.

While the sheet of recording paper is conveyed along the feeding path of paper conveying unit 1180, the sheet passes between the photoreceptor drum and the transfer device, and further passes through fixing unit 1190, whereby printing is done on the sheet of recording paper. The photoreceptor drum rotates in one direction and its surface is cleaned by the cleaning device and the eraser device, and thereafter uniformly charged by the charger. The laser scan unit modulates a laser beam based on the image data as the object of printing, and repeatedly scans the surface of photoreceptor drum with the laser beam in a main scanning direction, to form an electrostatic latent image on the surface of photoreceptor drum. The developer supplies toner to the surface of photoreceptor drum to develop the electrostatic latent image, and thereby forms a toner image on the surface of photoreceptor drum. The transfer device transfers the toner image on the surface of photoreceptor drum to the sheet of recording paper that is passing between the transfer device and the photoreceptor drum.

Fixing unit 1190 includes a heating roller for heating the sheet of recording paper and a pressure roller for pressing the sheet of recording paper. The sheet of recording paper is heated by the heating roller and pressed by the pressure roller, so that the toner image that has been transferred to the sheet of recording paper is fixed on the sheet. The sheet of recording paper discharged from the fixing device (printed sheet) is discharged to a paper discharge tray.

While image forming apparatus 1100 is in the power saving mode, when the activation signal from image display device 1200 is received, the mode changes from the power saving mode to the normal mode. Specifically, warming-up starts, and the state changes from the power saving state to the ready state. When the activation signal is received while the image forming apparatus is in the ready state, image forming apparatus 1100 is kept in the ready state.

<<Image Display Device 1200>>

Image display device 1200 includes: a display device 1210, a control unit 1220 for controlling various functional units; a communication unit 1230 for transmitting/receiving signals to/from an external device connected to image display device 1200; a program storage unit 1240 storing a program read and executed by control unit 1220 when the power of image display device 1200 is turned on; a temporary storage unit 1250 used by control unit 1220 as a temporary work memory, and a recording unit 1260 capable of retaining records when the power of image display device 1200 is turned off.

Display device 1210 is formed of a touch-panel display, including a display panel 1212 displaying an image on a prescribed display screen, and a touch-panel 1214 detecting which position on the display screen of display panel 1212 is touched by the user. Touch-panel 1214 has a function of detecting any touch and outputting a signal indicating that there has been a touch, and a function of outputting coordinate data representing the position touched at that time. In the present embodiment, touch-panel 1214 is of the infra-red scanning type. Display panel 1212 is a display panel such as a liquid crystal display panel capable of full-color display, and it displays an image processed by an image processing unit, not shown, on the display screen under the control of control unit 1220.

It is noted that a touch-panel other than the infrared scanning type panel (such as a capacitive type, surface acoustic wave type, resistive type touch-panel, or an infra-red camera type panel finding coordinates from a camera image) may be used as touch-panel 1214. A capacitive type panel and an infrared camera type panel are capable of detecting positions in non-contact manner if the distance to a sensor is sufficiently close.

Image display device 1200 is capable of executing various types of application software, and realizes functions corresponding to the application software. The application software includes a pen software that realizes drawing by a touch pen or the like (not shown), as a main function of image display device 1200. Specifically, the pen software enables image display device 1200 to successively read positional coordinates designated by the touch pen or the like on the display screen, and to display a track of input on display panel 1212 based on the read information. Thus, image display device 1200 can realize the drawing function such as hand-written input.

Program storage unit 1240 stores data and a program executed by control unit 1220 when the power of image display device 1200 is turned on, for enabling overall settings of image display device 1200. A program for realizing operations of image display device 1200 is also stored in program storage unit 1240. Recording unit 1260 is a non-volatile storage device retaining data even when the power is shut off and, for example, it is a hard disk drive, flash memory or the like. Recording unit 1260 may be detachable from image display device 1200. Recording unit 1260 may store part of the program executed by control unit 1220. In normal operation, control unit 1220 loads a program from program storage unit 1240 or from recording unit 1260 to temporary storage unit 1250, successively reads instructions from addresses designated by a program counter, not shown, and executes the instructions. Control unit 1220 controls various units and components forming image display device 1200 in accordance with the programs stored in program storage unit 1240 and recording unit 1260.

<<Information Processing Apparatus 1300>>

Information processing apparatus 1300 includes: an input unit 1310 for receiving an input based on an operation by a user; a processing unit 1320 for executing an application program for operating information processing apparatus 1300; a control unit 1330 for controlling various functional units forming information processing apparatus 1300; a storage unit 1340 storing various application programs to be executed by processing unit 1320; a time measuring unit 1350 for time management; and a communication unit 1360 for transmitting/receiving signals to/from an external device connected to information processing apparatus 1300.

A user can input an instruction to information processing apparatus 1300 by operating an operation device such as a keyboard or a mouse while viewing a display screen, not shown. The display screen and the operation device may be integrated to a configuration having both the display and input functions, such as a touch-panel display. Input unit 1310 receives an input by an operation by the user, and outputs an instruction signal in accordance with the input contents, to control unit 1330.

Processing unit 1320 reads and executes a necessary application program from storage unit 1340, in accordance with the instruction signal from control unit 1330. Processing unit 1320 includes a schedule management unit 1322 for executing a schedule management application program. The schedule management application program is a program for managing schedule of a user, and the schedule includes information related to a time zone and place in which a meeting is held, participants of the meeting and the like. The user can set his/her schedule at will using a setting screen image, not shown.

In addition to the schedule management application program, processing unit 1320 also executes a program for transmitting the activation signal causing image forming apparatus 1100 to make a transition from the power saving mode to the normal mode. The activation signal is transmitted through communication unit 1360 in response to detection that a time earlier by a prescribed time period than the end time of the meeting as managed by the schedule is reached based on the output of time measuring unit 1350. In the present embodiment, the activation signal is transmitted one minute before the end time of the meeting. Receiving the activation signal, image forming apparatus 1100 starts warming-up.

[Operation]

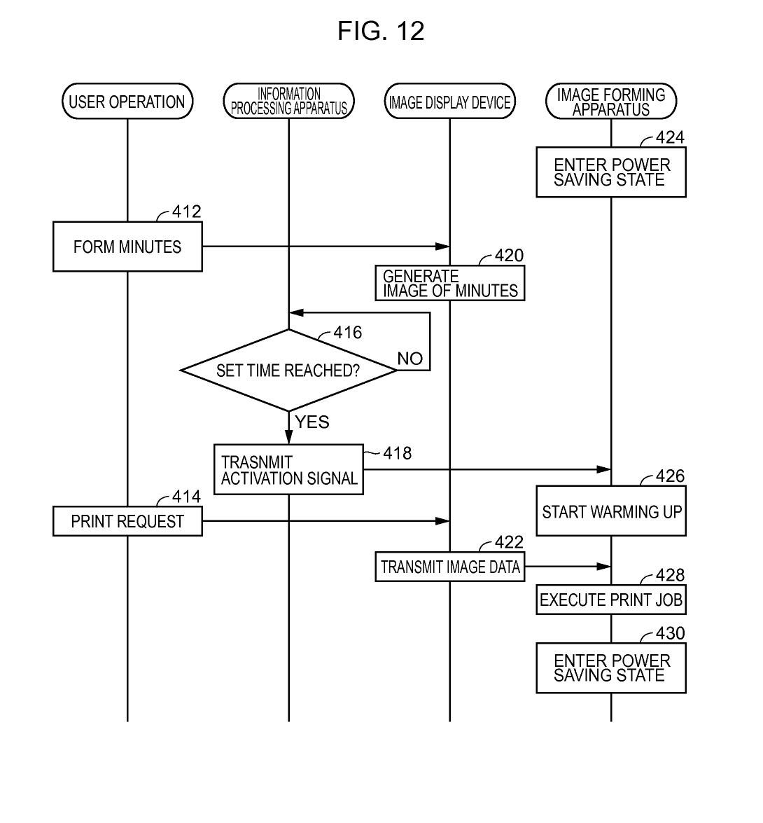

Referring to FIGS. 11 and 12, in image forming system 1050 in accordance with the present embodiment, the devices and apparatuses operate in the following manner. If image forming apparatus 1100 does not receive any instruction such as a print instruction for a prescribed time period or longer from the start of the meeting, image forming apparatus 1100 makes a transition from the ready state to the power saving state (step 424).

The user operates touch-panel 1214 of image display device 1200 as an input operation for instructing image display device 1200 to form and display minutes, image data and the like to be used in the meeting (step 412). Based on an instruction signal transmitted at step 412, control unit 1220 of image display device 1200 reads designated image data from temporary storage unit 1250 or recording unit 1260, generates image data for display, and displays on display panel 1212 (step 420).

Control unit 1330 of information processing apparatus 1300 determines whether or not a predetermined time is reached, by checking, at a prescribed interval, the output of time measuring unit 1350 (step 416). If the determination is negative, the control returns to step 416, and the determination is repeated periodically until the meeting reaches the set time. If the determination at step 416 is positive, the control proceeds to step 418, at which the activation signal is transmitted to image forming apparatus 1100 through communication unit 1230.

Receiving the activation signal from information processing apparatus 1300, image forming apparatus 1100 starts warming-up (step 426). Image forming apparatus 1100 returns from the power saving state through the warming-up state to the ready state.

The user operates touch-panel 1214 to input a print instruction, for printing the minutes and image data of materials of the meeting. In response to reception of the print instruction signal, control unit 1220 of image display device 1200 reads the designated image data from temporary storage unit 1250 or recording unit 1260, and transmits the image data to image forming apparatus 1100 (step 422). In response to communication unit 1150 of image forming apparatus 1100 receiving the image data, control unit 1130 causes image forming unit 1160 to execute printing of the image data (step 428). When execution of the print job at step 428 is completed and a prescribed time period or longer passes without receiving any instruction such as a print instruction, image forming apparatus 1100 again makes a transition to the power saving state.

[Functions and Effects]

According to the image forming system in accordance with the present embodiment, when one minute before the end time of the meeting is reached, the activation signal is automatically transmitted from information processing apparatus 1300 to image forming apparatus 1100. Receiving the activation signal, image forming apparatus 1100 starts warming-up, and makes a transition from the power saving state to the ready state. Thereafter, by the time when the user instruction to print the minutes of meeting or the like is received, printing can be executed upon reception of the instruction, since image forming apparatus 1100 has already been returned to the ready state. Therefore, as compared with the conventional image forming system in which image forming apparatus 1100 starts warming-up after the user gives a print instruction, the time from the input of print instruction by the user until the completion of printing can be made shorter. The participants are not kept waiting for a long time until the end of printing, and the minutes of meeting and the like can be printed and handed out to the participants at the end of or immediately after the meeting.

In the present embodiment, the schedule management application program is executed by information processing apparatus 1300, and the activation signal causing image forming apparatus 1100 to return to the ready state is issued from information processing apparatus 1300. The program, however, may be executed by image display device 1200. By way of example, a configuration may be possible in which the schedule management application program is stored in program storage unit 1240 of image display device 1200 and control unit 1220 reads the program and executes the process of transmitting the activation signal. In that case, the image forming system can be implemented by two components, that is, image forming apparatus 1100 and image display device 1200. Operations such as schedule setting and request for printing can be done by using only the image display device 1200, which is convenient for the user.

Though the timing to transmit the activation signal is set to one minute before the end time of the meeting in the present embodiment, the timing of transmission is not limited thereto. The signal may be transmitted at such timing that the time from the transmission of activation signal to the start of printing becomes longer than the minimum time necessary for the warming-up.

In the present embodiment, when one minute before the end time of the meeting is reached, information processing apparatus 1300 transmits the activation signal once to image forming apparatus 1100. The timing and the number of times the activation signal is transmitted may not be limited to the above. By way of example, a schedule may be set such that five minutes before the end time of the meeting, the activation signal is transmitted for the first time, and thereafter the activation signal is transmitted repeatedly at a prescribed interval for a while. By such an approach, it follows that the image forming apparatus 1100 is kept in the ready state for some time, from five minutes before the end time of the meeting. Therefore, if the meeting ends some time before or after the expected end time, it is possible for the user to have printing started immediately, using image forming apparatus 1100, and the minutes or the like can be handed out without keeping the participants waiting. Here, the time to end transmission of activation signal may be set beforehand.

Though the activation signal is transmitted by information processing apparatus 1300 in the present embodiment, it may be transmitted by the image forming apparatus itself. By way of example, the following configuration may be possible. A server having a function of collectively managing schedules individually registered by each of a plurality of users is connected to the image forming apparatus. Based on the contents of schedule of the meeting transmitted from the server (including information related to the start time, end time, and participants of the meeting), the image forming apparatus sets the activation signal to be transmitted to various functional units before the end time of the meeting. In this configuration, even when there is a plurality of users who register the schedules, each user have only to input the expected meeting, and the server collectively manages the plans of registered meetings. The image forming apparatus automatically issues the activation signal to various functional units so that the image forming apparatus returns to the ready state by the end time of the meeting. The above-described server function may be installed in the image forming apparatus and the image forming apparatus my collectively manage the schedules of users.

### Third Embodiment

The image forming system in accordance with the present embodiment is different from the image forming system in accordance with the second embodiment in that the activation signal is transmitted based on the result of analysis of image data obtained by video-recording images around the image display device or analysis of voice data obtained by recording voices around the image display device. Except for this point, the configuration of image forming system is the same as that of the second embodiment.

[Appearance of Image Display Device 1500]

An image display device 1500 in accordance with the present embodiment is provided with a camera 1570 for picking up images around image display device 1500 above a display device 1510, and a microphone 1580 for recording voices around image display device 1500 below display device 1510.

In the present embodiment, it is assumed that image display device 1500 is arranged in front of participants, and at the start of the meeting, the participants respectively take designated seats. Therefore, camera 1570 picks up images of participants moving to and sitting down on their seats before the start of the meeting and images of participants standing up from their seats after the end of the meeting.

Generally, participants chat before and after the meeting and, therefore, microphone 1580 records voices of people. On the other hand, after the start of meeting, it follows that microphone 1580 mainly records the voice of a participant who has a say. Generally, at a meeting, the voice heard is mostly of the participant who has a say at that time. Therefore, the number of speakers of the voices recorded by microphone 1580 differs depending on whether the meeting is in progress or not.

[Hardware Configuration]

<<Image Display Device 1500>>

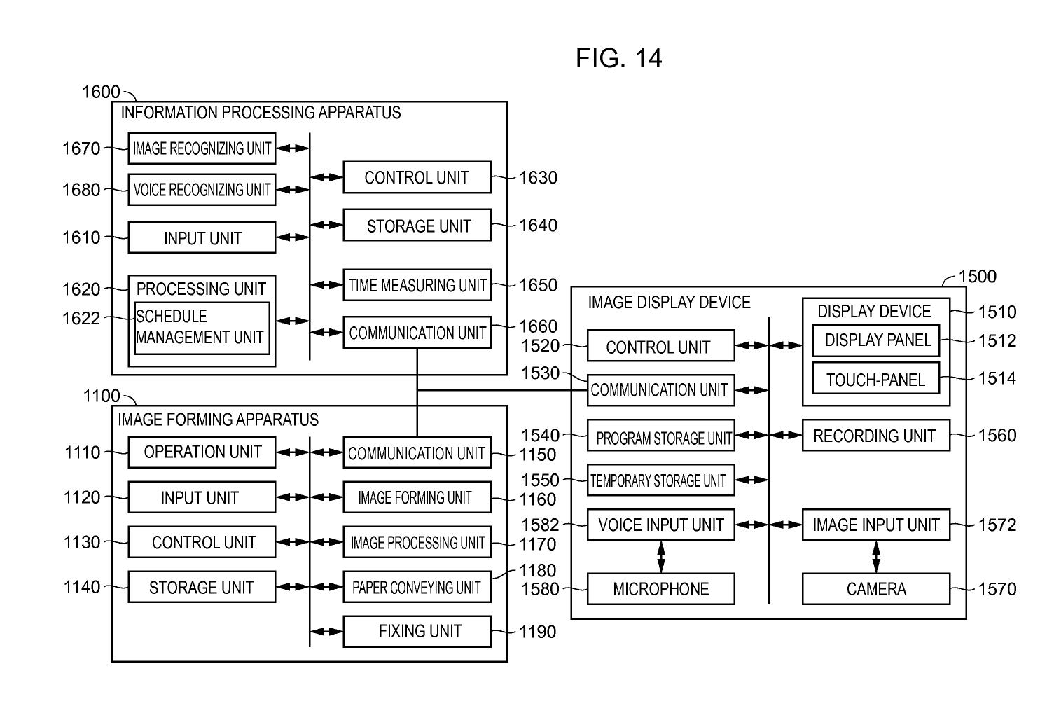

Referring to FIG. 14, image display device 1500 is different from image display device 1200 (see FIG. 11) in that it includes camera 1570, microphone 1580, an image input unit 1572 for recording images picked up by camera 1570 as image data in a temporary storage unit 1550 or a recording unit 1560, and a voice input unit 1574 for recording voices recorded by microphone 1580 as voice data in temporary storage unit 1550 or recording unit 1560. Other functional units 1510 to 1560 have the same functions as functional units 1210 to 1260 of image display device 1200 and, therefore, accumulative description will not be given here.

<<Information Processing Apparatus 1600>>

Information processing apparatus 1600 is different from information processing apparatus 1300 in that it includes an image recognizing unit 1670 for analyzing image data, and a voice recognizing unit 1680 for analyzing voice data. Other functional units 1610 to 1660 have the same functions as functional units 1310 to 1360 of information processing apparatus 1300.

[Operation]

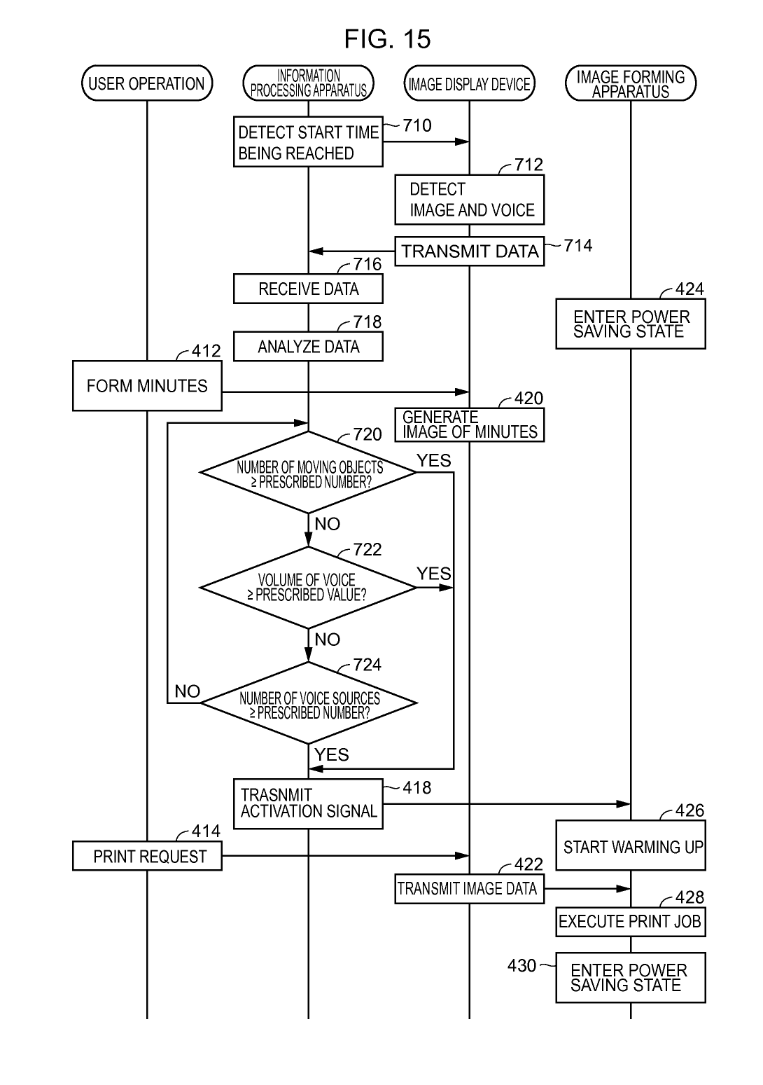

Referring to FIGS. 14 and 15, the image forming system in accordance with the present embodiment operates in the following manner. The processes at steps 412 to 414 and 418 to 430 are the same as those of respective steps shown in FIG. 12.

When time measuring unit 1650 detects that the set time (start time of the meeting) managed by the schedule management application program is reached, control unit 1630 transmits a signal notifying the start of meeting to image display device 1500 through communication unit 1660 (step 710).

In response to reception of the signal transmitted at step 710, image display device 1500 starts detection of images by camera 1570 and detection of voice by microphone 1580 (step 712). Control unit 1520 transmits the image data and voice data obtained by the detection to information processing apparatus 1600 at a constant interval, through communication unit 1530 (step 714).

Communication unit 1660 receives the image data and voice data transmitted at step 714 (step 716), and image recognizing unit 1670 analyzes the image data and voice recognizing unit 1680 analyzes the voice data, respectively (step 718).

Image recognizing unit 1670 analyzes the image data and counts how many objects are moving. During the meeting, the participants are seated, and image recognizing unit 1670 does not recognize a seated participant as a “moving object.” When the meeting ends and participants stand up, image recognizing unit 1670 recognizes the participants as “moving objects.” In this manner, image recognizing unit 1670 counts how may moving objects are there, and transmits the count to control unit 1630.

Voice recognizing unit 1680 analyzes the voice data and calculates the volume of recorded voices and sources of the voices. It is the case that participants stay silent except for the speaker during the meeting and, therefore, the volume and the number of sources of the voices are both smaller than after the meeting. Voice recognizing unit 1680 transmits the result of calculation to control unit 1630.

At step 720, control unit 1630 determines whether or not the count of “moving objects” counted by image recognizing unit 1670 is equal to or larger than a prescribed number. If the result of determination is positive, the control proceeds to step 418, and if it is negative, the control proceeds to step 722.

At step 722, control unit 1630 determines whether the volume calculated by voice recognizing unit 1680 is equal to or higher than a prescribed value. If the result of determination is positive, the control proceeds to step 418, and if it is negative, the control proceeds to step 724.

At step 724, control unit 1630 determines whether the number of voice sources calculated by voice recognizing unit 1680 is equal to or larger than a prescribed number. If the result of determination is positive, the control proceeds to step 418, and if it is negative, the control again returns to step 720.

The prescribed number or the prescribed value as the reference for determination at steps 720 to 724 is determined in advance by the user and managed by the schedule management application program. The user sets the prescribed number and the prescribed value in accordance with pieces of information including the number of participants of the meeting, the area and environment of the place of meeting, the position of image display device 1500 and the cast of participants, before the start of meeting.

If any of the determinations made from step 720 to 724 is positive, control unit 1630 determines that the meeting ended, and it transmits the activation signal to image forming apparatus 1100 (step 418). Receiving the activation signal, image forming apparatus 1100 starts warming-up (step 426), and returns to the ready state.

If the determinations at steps 720 to 724 are all negative, the control again returns to step 720. Since image display device 1500 transmits the image data and the voice data to information processing apparatus 1600 at a constant interval (step 714), the analysis of these data (step 718) and the determinations of results of analysis (steps 720 to 724) are also periodically repeated until the control proceeds to step 418.

[Functions and Effects]

By the image forming system in accordance with the present embodiment, when it is detected that the meeting ends and a prescribed number or more of the participants of meeting stand up and leave their seats, or many participants start chatting, the activation signal is automatically transmitted from information processing apparatus 1600 to image forming apparatus 1100. Therefore, it is possible to detect an end of a meeting even if the end time of the meeting is not defined, and hence, power supply to image forming apparatus 1100 can be started quickly. By the time the user issues a print instruction, image forming apparatus 1100 has already been warmed up, and the participants are not kept waiting for a long time until printing of minutes of the meeting is completed.

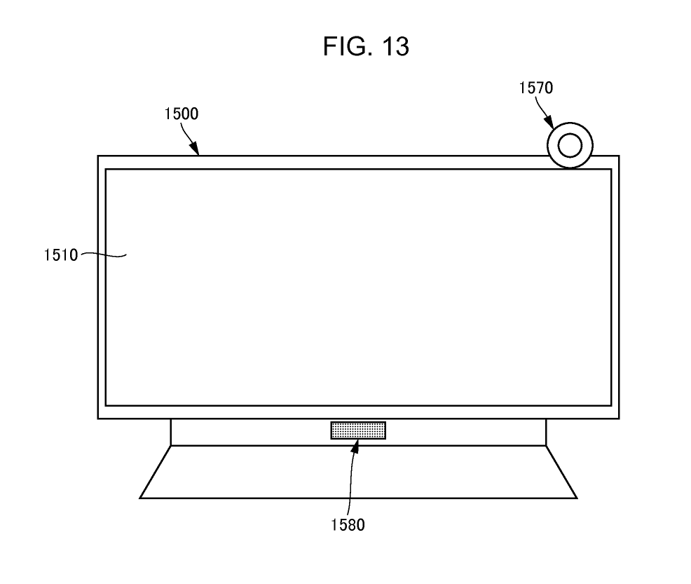

In the present embodiment, camera 1570 and microphone 1580 are mounted on the image display device at positions shown in FIG. 13. It is noted, however, that the camera and microphone may be mounted at positions other than those shown in FIG. 13. By way of example, a configuration is possible in which data are acquired using a camera and a microphone of an external device, and the data are transmitted to information processing apparatus 1600.

As in the second embodiment, the schedule management application program may be executed by image display device 1500 in the present embodiment also. Here, by adapting control unit 1520 of image display device 1500 to issue an instruction to transmit the activation signal to image forming apparatus 1100, it is possible to form the image forming system by two components, that is, image forming apparatus 1100 and image display device 1500.

In the present embodiment, that the start time of a meeting is reached is detected using the schedule management application program. The detection of start time, however, is not limited to the method above. By way of example, a configuration is possible in which the start of meeting is determined, using camera 1570 and microphone 1580, by detecting that the number of moving objects is equal to or smaller than a prescribed number, that the volume of recorded voice is equal to or lower than a prescribed value, or that the number of voice sources is equal to or smaller than a prescribed number. By such a configuration, it is possible to detect the start and the end of meeting even if the schedule management application program is not stored in storage unit 1640. Further, even when the start time and the end time of the meeting are not defined, the start and end can be detected. By this approach, the schedule management application program becomes unnecessary and, therefore, if control unit 1520 is adapted to transmit the activation signal, the image forming system can be formed simply by image forming apparatus 1100 and image display device 1500.

In the present embodiment, three objects area detected, that is, the number of moving objects, the volume of recorded voice and the number of voice sources. The number of objects to be detected may be one or two. For example, only the microphone may be mounted and the camera may not be mounted on the image display device, and determination may be made by whether the volume of recorded voice is equal to or higher or the number of voice sources is equal to or higher than a prescribed number. Alternatively, only the camera may be mounted and the microphone is not mounted on the image display device, and the determination may be made by whether the number of moving objects detected from the recorded image is equal to or larger than a prescribed number.

### Fourth Embodiment

In the following, an example in which the present invention is applied to an electronic blackboard apparatus as an example of the image display device will be described.

[Overall System Configuration]

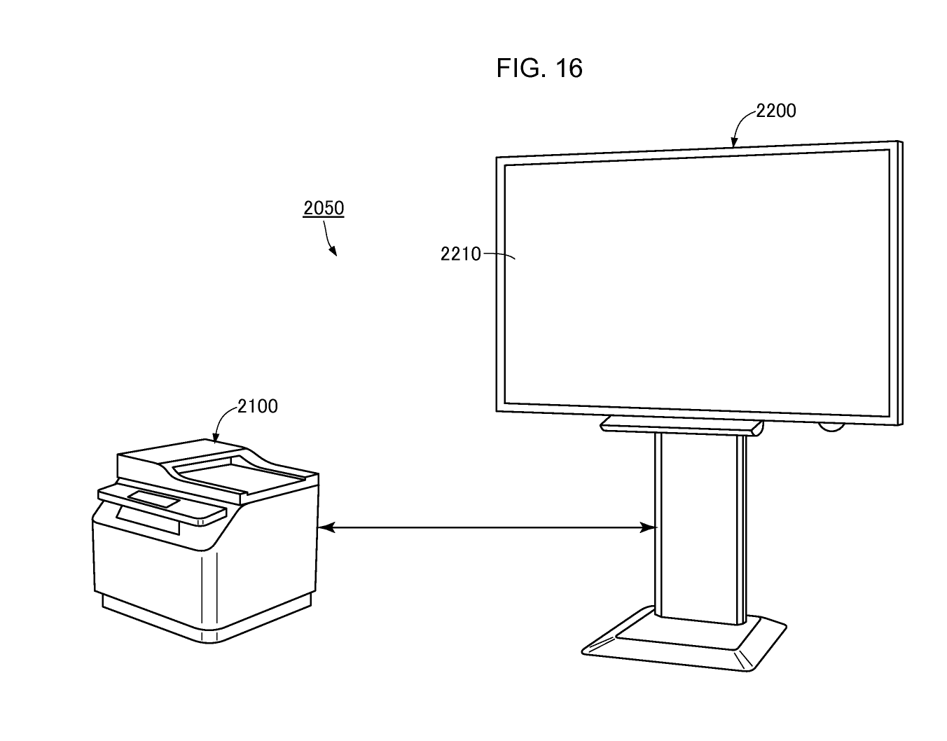

Referring to FIG. 16, an overall configuration of image forming system 2050 in accordance with the present embodiment will be described. Image forming system 2050 includes an image forming apparatus 2100, and an electronic blackboard apparatus 2200 connected to image forming apparatus 2100. Image forming apparatus 2100 and electronic blackboard apparatus 2200 transmit/receive signals to/from each other.

Image forming apparatus 2100 is a multifunctional peripheral having, for example, copy, printer and facsimile functions. Image forming apparatus 2100 has a so-called laser type (electrophotographic) printing function using a laser beam for exposure. The apparatus, however, may have a different type printing function.

Image forming apparatus 2100 has the normal mode, which corresponds to the normal power conduction state (ready state) and the energy saving mode (power saving mode) which corresponds to the energy saving state in which power consumption is reduced. Image forming apparatus 2100 is configured to make a transition from the normal mode to the energy saving mode if a state in which no instruction of printing or the like is received continues for a prescribed time period, to reduce power consumption.

The normal mode represents a state of standby, waiting for an instruction of printing or the like. If a print instruction (print job) is received in the normal mode, image forming apparatus 2100 immediately executes printing. When a prescribed time period passes without an instruction of printing or other operation, image forming apparatus 2100 makes a transition from the normal mode to the power saving mode for reducing power consumption. In the power saving mode, in order to reduce power consumption, electric power is supplied only to necessary portions. In the power saving mode, power supply to a fixing unit (not shown), which will be described later, for image formation is also reduced. Therefore, in the power saving mode, image forming apparatus cannot immediately execute any process if a print instruction or the like is received, and recovery to enter the normal mode is necessary. Generally, when image data transmitted from an external device such as a personal computer (PC) or a facsimile is received in the power saving mode, image forming apparatus 2100 starts recovery to the normal mode. After a prescribed time period from the recovery to the normal mode, the image forming apparatus again makes a transition to the power saving mode.

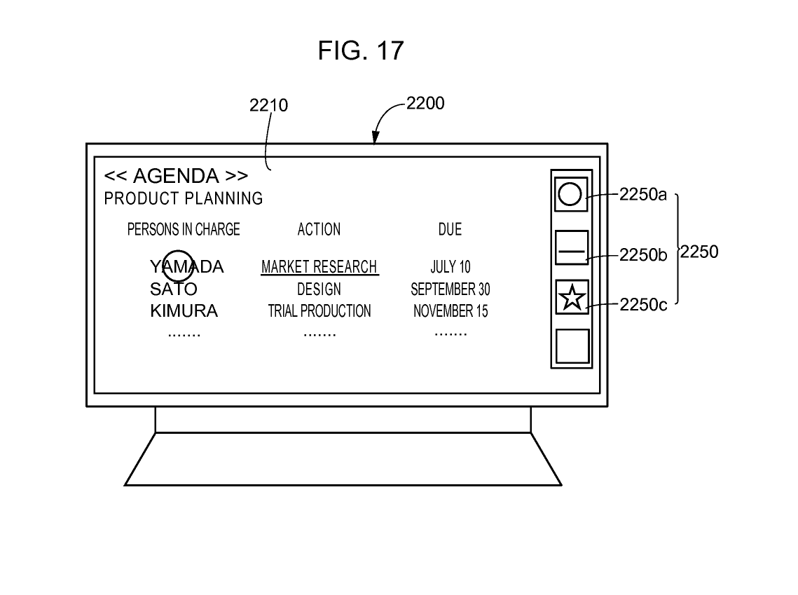

Electronic blackboard apparatus 2200 includes a display device 2210 having a large display screen, and a control device 2220 (see FIG. 17) implemented by a computer. Details of control device 2220 will be described later. In the present image forming system 2050, electronic blackboard apparatus 2200 is connected to image forming apparatus 2100, whereby it becomes possible to print an image or the like displayed on electronic blackboard apparatus 2200 by image forming apparatus 2100.

It is assumed that in the present embodiment, electronic blackboard apparatus 2200 (image forming system 2050) is used for a meeting or the like.

Referring to FIG. 17, when electronic blackboard apparatus 2200 is used for a meeting, for example, it is a common practice to form minutes using electronic blackboard apparatus 2200, and to print and hand out the formed minutes of meeting to participants, at the end of meeting. When minutes are written on electronic blackboard apparatus 2200 and thereafter the meeting is closed, in order to reconfirm the contents of meeting, it is common to surround a name of a project leader with a circle, or to draw a line under a series of characters representing, for example, an action item (the action to be taken next by the participants, determined during the meeting). The action of surrounding the name of a project leader or drawing a line under a series of characters representing an action item or a due date can be considered to be an action of closing the meeting.

Electronic blackboard apparatus 2200 detects such an operation (marking operation), and in response to the detection, transmits the activation signal for switching image forming apparatus 2100 from the energy saving mode to the normal mode, to image forming apparatus 2100. Specifically, electronic blackboard apparatus 2200 predicts the end of meeting by detecting that such a marking operation is done (received), and transmits in advance the activation signal before the start of printing, so as to have image forming apparatus 2100 in the normal mode when the minutes are to be printed. Receiving the activation signal, image forming apparatus 2100 starts a recovery (activation) and, after a prescribed warming-up time, returns to the normal state. When an instruction to print is issued by an operation by the user for printing the formed minutes, electronic blackboard apparatus 2200 transmits the image data of minutes together with a command for printing the image data of minutes to image forming apparatus 2100. When image forming apparatus 2100 receives the command, image forming apparatus 2100 has already been recovered (activated) and, printing can be started.

[Hardware Configuration]

<<Electronic Blackboard Apparatus 2200>>

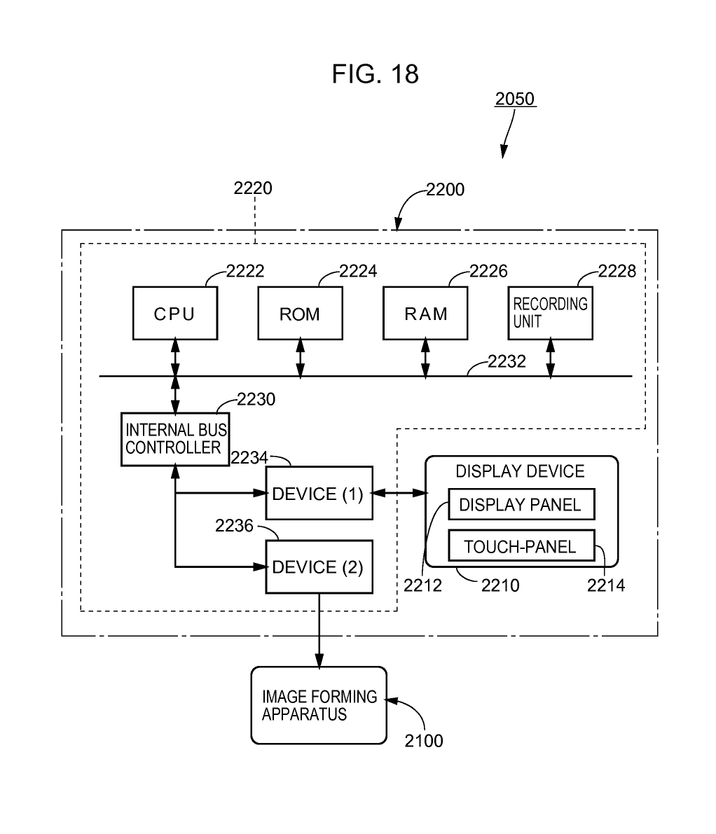

Referring to FIG. 18, electronic blackboard apparatus 2200 includes a display device 2210 of a large screen, and a control device 2220 implemented by a computer.

Control device 2220 is formed of an information processing apparatus such as a personal computer and attached, for example, to a prescribed portion, for example, on a back side surface of display device 2210. Control device 2220 includes: a central processing unit (CPU) 2222 executing a prescribed program for realizing overall control of electronic blackboard apparatus 2200; a read only memory (ROM) 2224 for storing a program read by CPU 2222 when electric power to electronic blackboard apparatus 2200 is turned on; a random access memory (RAM) 2226 used by CPU 2222 as a work memory; a recording unit 2228 capable of retaining records when electric power to electronic blackboard apparatus 2200 is shut off; an internal bus controller 2230 controlling data transmission/reception between display device 2210 and image forming apparatus 2100, in accordance with a control from CPU 2222; and a bus 2232 connecting these components with each other and enabling communication of data and control signals between each other.

Control device 2220 further includes: a device (1) 2234 connected to internal bus controller 2230 for outputting a signal to display device 2210 under the control of internal bus controller 2230; and a device (2) 2236 serving as an interface connected to internal bus controller 2230 and providing connection with an external device (in the present embodiment, image forming apparatus 2100) under the control of internal bus controller 2230. Device (1) 2234 and device (2) 2236 include a connector and its control chip (control circuit). The connector above includes, for example, RS232C and US (Universal Serial Bus).

ROM 2224 stores data and a program executed by CPU 2222 when the power of electronic blackboard apparatus 2200 is turned on, for allowing overall settings of electronic blackboard apparatus 2200 to realize prescribed operations of electronic blackboard apparatus 2200. A program for realizing operations of electronic blackboard apparatus 2200 is also stored in ROM 2224. Recording unit 2228 is a non-volatile storage device retaining data even when the power is shut off and, for example, it is a hard disk drive, flash memory or the like. Recording unit 2228 may be detachable from electronic blackboard apparatus 2200. Recording unit 2228 may store part of the program executed by CPU 2222. In normal operation, CPU 2222 loads a program from ROM 2224 or from recording unit 2228 to RAM 2226, successively reads instructions from addresses designated by a program counter, not shown, and executes the instructions. CPU 2222 controls various units and components forming electronic blackboard apparatus 2200 in accordance with the programs stored in ROM 2224 and recording unit 2228.

Display device 2210 is formed of a touch-panel display, including a display panel 2212 displaying an image on a prescribed display screen, and a touch-panel 2214 detecting which position on the display screen of display panel 2212 is touched by the user. Touch-panel 2214 has a function of detecting any touch and outputting a signal indicating that there has been a touch, and a function of outputting coordinate data representing the position touched at that time. In the present embodiment, touch-panel 2214 is of the infra-red scanning type. Display panel 2212 is a display panel such as a liquid crystal display panel capable of full-color display, and it displays an image processed by an image processing unit, not shown, on the display screen under the control of CPU 2222.

It is noted that a touch-panel other than the infrared scanning type panel (such as a capacitive type, surface acoustic wave type, resistive type touch-panel, or an infra-red camera type panel finding coordinates from a camera image) may be used as touch-panel 2214. A capacitive type panel and an infrared camera type panel are capable of detecting positions in non-contact manner if the distance to a sensor is sufficiently close.

Electronic blackboard apparatus 2200 is capable of activating various types of application software, and realizes functions corresponding to the activated application software. The application software includes a pen software that realizes drawing by a touch pen or the like (not shown), as a main function of electronic blackboard apparatus 2200. Specifically, electronic blackboard apparatus 2200 successively reads positional coordinates designated by the touch pen or the like on the display screen, and displays a track of input on display panel based on the read information. Thus, electronic blackboard apparatus 2200 can realize the drawing function such as hand-written input.

Referring to FIG. 17, the pen software has an icons 2250 for marking prepared in advance on the display screen of electronic blackboard apparatus 2200. Icons 2250 include, for example, an icon 2250a for displaying a circle (∘), an icon 2250b for displaying an underline, and an icon 2250c for summary. By touching icon 2250a and thereafter touching a position where a circle (∘) is to be displayed, a circle (∘) is displayed at the touched position. By touching icon 2250b and thereafter touching a position where an underline is to be displayed, an underline is displayed at the touched position. By touching icon 2250c, a form for summary is displayed. By way of example, when icon 2250c is touched, characters “SUMMARY” and a frame or a star are displayed. In this manner, by touching any of icons 2250, an image (drawings) corresponding to the icon is pasted on the display screen.

These icons are used, for example, for forming the minutes. If touching of any of icons 2250 is detected, in response to the detection, electronic blackboard apparatus 2200 transmits the activation signal for recovery (activation) of image forming apparatus 2100, to image forming apparatus 2100. In the present embodiment, “touch operation” includes a drawing operation such as a hand-written input.

<<Image Forming Apparatus 2100>>

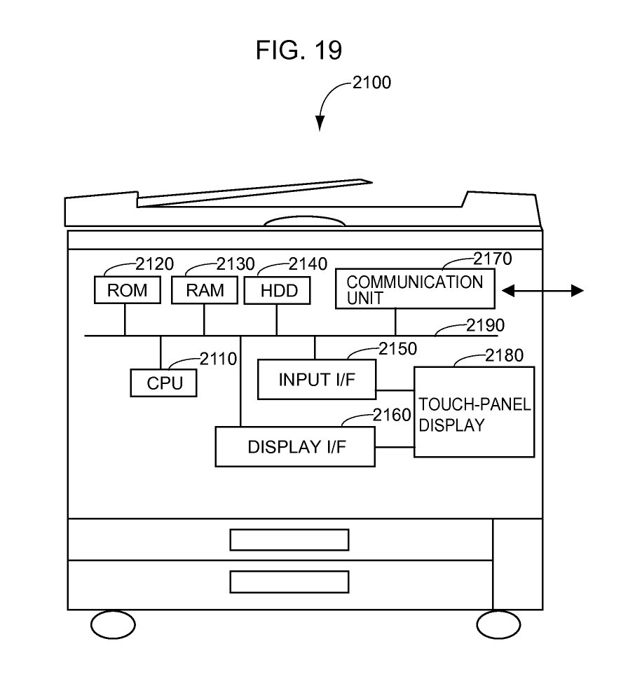

Referring to FIG. 19, image forming apparatus 2100 includes a bus 2190, a CPU 2110 connected to bus 2190, an ROM 2120 connected to bus 2190, an RAM 2130 connected to bus 2190, an HDD (Hard Disk Drive) 2140 connected to bus 2190, an I/F 2150 and a display I/F 2160, connected to bus 2190, for providing an interface related to connection with touch-panel display 2180, and a communication unit 2170 connected to bus 2190, for providing a wired or wireless (in the present embodiment, wired) connection to electronic blackboard apparatus 2200.

Bus 2190, ROM 2120, RAM 2130, HDD 2140, input I/F 2150, display 1/F 2160 and communication unit 2170 all operate in a cooperated manner under the control of CPU 2110, and realizes print, copy and other processes in image forming apparatus 2100. These processes are executed by various components, not shown in FIG. 19, of image forming apparatus 2100, controlled by CPU 2110.

Image forming apparatus 2100 includes, for example, a document reading unit, an image forming unit, a paper feeding unit and a paper discharge device. In image forming apparatus 2100, image data received from electronic blackboard apparatus 2200 is subjected to various image processing operations by CPU 2110, and the resulting image data is output to the image forming unit.

The image forming unit is for printing an image represented by the image data on recording paper, and the image forming unit includes, for example, a photoreceptor drum, a charger, a laser scan unit, a developer, a transfer device, a cleaning device, a fixing device and an eraser device. A feeding path is provided in the image forming unit, and a sheet of recording paper fed from a paper feed unit is conveyed along the feeding path. The paper feed unit draws out sheets of recording paper held in a paper cassette or placed on a manual feed tray one by one and feeds to the feeding path of the image forming unit.

While the sheet of recording paper is conveyed along the feeding path of the image forming unit, the sheet passes between the photoreceptor drum and the transfer device, and further passes through the fixing unit, whereby printing is done on the sheet of recording paper.

The photoreceptor drum rotates in one direction and its surface is cleaned by the cleaning device and the eraser device, and thereafter uniformly charged by the charger. The laser scan unit modulates a laser beam based on the image data as the object of printing, and repeatedly scans the surface of photoreceptor drum with the laser beam in a main scanning direction, to form an electrostatic latent image on the surface of photoreceptor drum. The developer supplies toner to the surface of photoreceptor drum to develop the electrostatic latent image, and thereby forms a toner image on the surface of photoreceptor drum.

The transfer device transfers the toner image on the surface of photoreceptor drum to the sheet of recording paper that is passing between the transfer device and the photoreceptor drum. The fixing device includes a heating roller for heating the sheet of recording paper and a pressure roller for pressing the sheet of recording paper. The sheet of recording paper is heated by the heating roller and pressed by the pressure roller, so that the toner image that has been transferred to the sheet of recording paper is fixed on the sheet. The sheet of recording paper discharged from the fixing device (printed sheet) is discharged to a paper discharge tray.

When the activation signal from electronic blackboard apparatus 2200 is received, image forming apparatus 2100 switches from the energy saving mode to the normal mode. Specifically, it starts to return to the normal mode. When the activation signal is received while the apparatus is in the normal mode, image forming apparatus maintains the state of normal mode.

[Software Configuration]

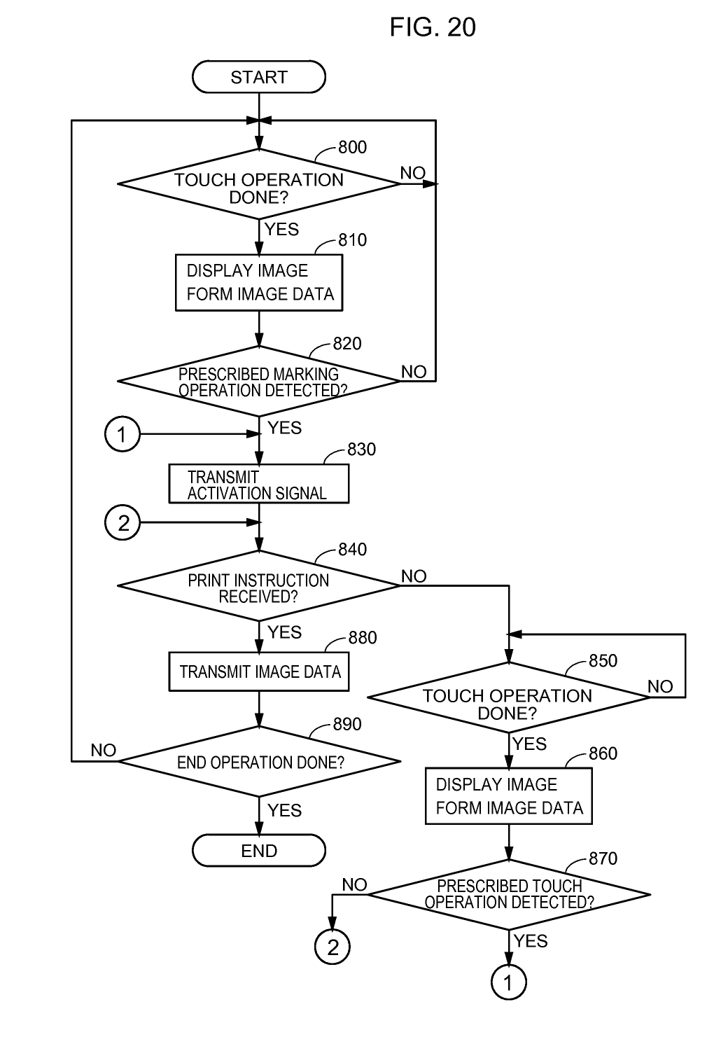

Referring to FIG. 20, the control structure of a computer program executed by electronic blackboard apparatus 2200 in image forming system 2050 in accordance with the present embodiment will be described. The program is activated when application software having the printing function such as pen software is activated.

The program includes: a step 800 of determining whether or not a touch operation by a touch pen or the like is done, and waiting for a touch operation; a step 810, executed if it is determined at step 800 that a touch operation is done, of receiving the touch operation (drawing device) by the touch pen or the like, displaying an image on the display screen, and forming image data of the displayed image; a step 820, executed after step 810, of determining whether or not a prescribed marking operation (touch operation) is detected, and branching the flow of control depending on the result of determination; and a step 830, executed if it is determined at step 820 that the prescribed marking operation is detected, of transmitting the activation signal for activating image forming apparatus 2100, to image forming apparatus 2100.

At step 820, if any of icon 2250a for displaying (drawing) a circle (0), icon 2250b for displaying (drawing) an underline, and icon 2250c for summary is touched, it is determined that the prescribed marking operation has been done. Specifically, the prescribed marking operation is detected. If it is determined at step 820 that the prescribed marking operation is not detected, the control returns to step 800.

The program further includes a step 840, executed after step 830, of determining whether or not a print instruction is given by the user, and branching the flow of control depending on the result of determination; a step 850, executed if it is determined at step 840 that the print instruction is not given, of determining whether or not a touch operation (drawing operation) by a touch pen or the like is done, and waiting until a touch operation is done; a step 860, executed if it is determined at step 850 that a touch operation has been done, of receiving the touch operation by the touch pen or the like, displaying an image on the display screen, and forming image data of the displayed image; and a step 870, executed after step 860, of determining whether a prescribed marking operation (touch operation) is detected, and branching the flow of control depending on the result of determination.

If it is determined at step 870 that the prescribed marking operation is detected, the control returns to step 830, and if it is determined that the prescribed operation is not detected, the control returns to step 840.

The program further includes: a step 880, executed if it is determined at step 840 that a print instruction is given, of transmitting a command for executing printing and image data to image forming apparatus 2100; and a step 890, executed after step 880, of determining whether an end operation is done by the user, and branching the flow of control depending on the result of determination.

At step 890, if it is determined that an end operation is done by the user, the program ends. On the other hand, if it is determined that the end operation is not done by the user, the control returns to step 800. The end operation by the user includes, for example, an operation of ending the present application software.

[Operation]

Image forming system 2050 in accordance with the present embodiment operates in the following manner. In the following, of the operations of electronic blackboard apparatus 2200, only the portions related to the present invention will be described. Other operations are the same as those of conventional electronic blackboard apparatus 2200.

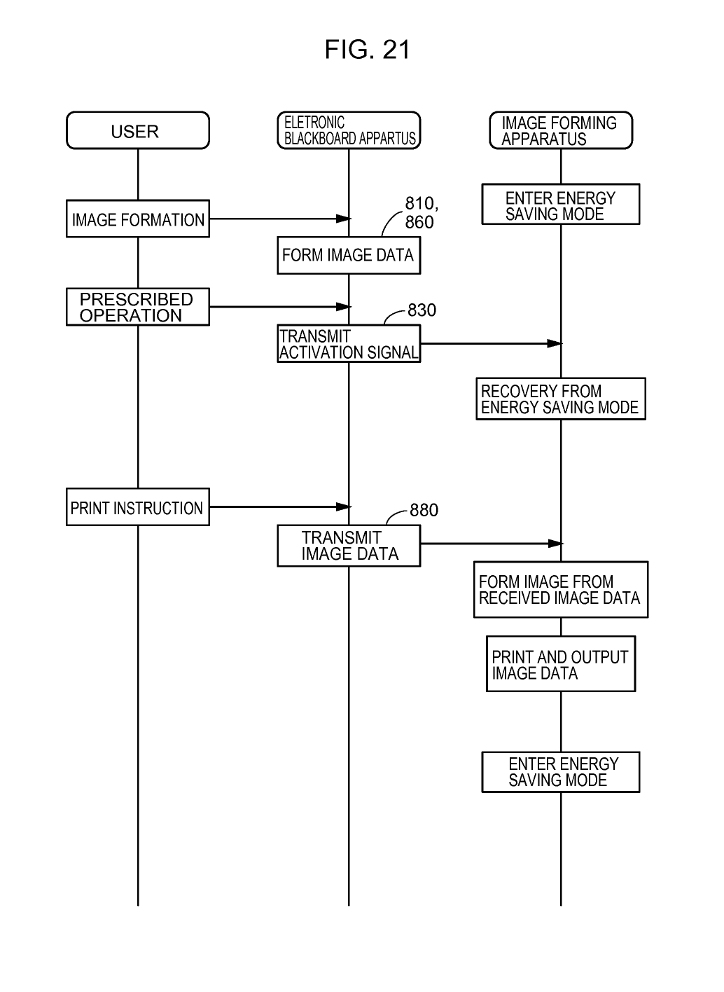

Assume that a meeting is held, where electronic blackboard apparatus 2200 is used. Referring to FIG. 21, when the user draws (forms an image) on electronic blackboard apparatus 2200 using a touch pen, electronic blackboard apparatus 2200 receives the touch operation by the user and displays the drawn image on the display screen. Electronic blackboard apparatus 2200 forms image data of the image (displayed image) displayed on the display screen (step 810 of FIGS. 20 and 21). When the user performs a prescribed operation (prescribed touch operation) on electronic blackboard apparatus 2200, electronic blackboard apparatus 2200 transmits the activation signal to image forming apparatus 2100.

Generally, at a meeting, the data of displayed images having notes written by a touch pen or the like on electronic blackboard apparatus 2200 is printed as minutes at the end of meeting, and handed out to the participants. In image forming system 2050 of the present embodiment, focusing on the operation done by the user at the end of the meeting, the marking operation for confirming the minutes at the end of meeting is used as a trigger to activate image forming apparatus 2100.

Referring to FIG. 17, when the meeting is to be closed after writing agendas and topics on electronic blackboard apparatus 2200, it is a common practice to surround a name of a project leader with a circle, or to draw a line under a series of characters, for the purpose of re-confirming the contents of meeting. When the name is to be surrounded by a circle (∘), by touching icon 2250a and thereafter touching the name of intended person, the name is surrounded by the circle. The size, thickness and the like of the circle can be changed as desired. Similarly, when an action item and a due date are to be underlined, by touching icon 2250b of underline and thereafter drawing a line under the desired series of characters, the characters are underlined. The thickness, color and the like of underline can be changed as desired.

Such a marking operation is done at the last part of the meeting and, therefore, if it is detected that such a marking operation as the prescribed operation is done, electronic blackboard apparatus 2200 transmits the activation signal to image forming apparatus 2100. It is noted that marking is not done only by touching icon 2250a or 2250b. However, when marking is to be done, one of icons 2250 is always touched and, therefore, the marking operation in accordance with the present embodiment includes the operation of touching any of icons 2250.

Again referring to FIG. 21, assume that image forming apparatus 2100 has made a transition to the energy saving mode. Receiving the activation signal transmitted from electronic blackboard apparatus 2200, image forming apparatus 2100 switches its mode from the energy saving mode to the normal mode. Specifically, it starts returning to the normal mode. After receiving the activation signal, image forming apparatus 2100 returns to the normal mode after a prescribed time of warming-up (recovery from energy saving mode).

When the user instructs printing (print instruction) to electronic blackboard apparatus 2200, electronic blackboard apparatus 2200 transmits the image data to image forming apparatus 2100. Receiving the image data, image forming apparatus 2100 forms images based on the received image data, and executes the print process. Thereafter, when a prescribed time period passes without any operation to image forming apparatus 2100 or without reception of any image data, image forming apparatus 2100 again makes a transition to the energy saving mode.

[Functions and Effects]

As is apparent from the foregoing description, use of image forming system 2050 in accordance with the present embodiment attains the following effects.

Electronic blackboard apparatus 2200 receives touch operations and displays drawn images. Further, electronic blackboard apparatus 2200 receives an operation of one of icons 2250 by a touch, and displays an image corresponding to the touched one of icons 2250. In response to a touch operation of icons 2250, electronic blackboard apparatus 2200 transmits the activation signal to image forming apparatus 2100. Receiving the activation signal from electronic blackboard apparatus 2200, image forming apparatus 2100 starts recovery to the normal power conduction state (ready state). Thus, it is possible to have image forming apparatus 2100 easily returned to the normal state. In addition, when the image (such as the minutes) displayed on electronic blackboard apparatus 2200 is to be printed by image forming apparatus 2100, it is possible to start recovery of image forming apparatus 2100 in advance, before transmitting the image data to image forming apparatus 2100. Therefore, the time from transmission of image data to printing can effectively be reduced. Further, whether any of icons 2250 is touched or not can easily be detected and, therefore, detection of the prescribed touch operation does not take time. Thus, the activation signal can be transmitted quickly. Therefore, the wait time for the user related to the recovery of image forming apparatus 2100 can effectively be made shorter.

The marking operation of surrounding the name of a person in charge, or underlining a series of characters, using icons 2250, is an operation effected at the end of a meeting. Since the activation signal is transmitted to image forming apparatus 2100 at the timing of such marking operation, it becomes possible to have image forming apparatus 2100 recovered (activated) by the time printing of minutes is to be done. Thus, the marking operation can be regarded as an operation done at the timing considering the time necessary for recovery from the energy saving mode to the normal mode. Therefore, by transmitting the activation signal at the timing of touching one of the icons 2250, the wait time for the user related to the recovery of image forming apparatus 2100 can more effectively be made shorter.

Further, the marking operation of surrounding the name of a person in charge, or underlining a series of characters, using icons 2250, is an operation frequently done before the end of a meeting. Therefore, it is possible to transmit the activation signal to image forming apparatus 2100 without necessitating any special operation. Specifically, it is possible to predict start of printing based on a normal manner of use of electronic blackboard apparatus 2200 and to transmit the activation signal in advance to image forming apparatus 2100. Thus, it follows that image forming apparatus 2100 has already been returned to the normal power conduction state (ready state) by the end time of the meeting, and hence, printing by image forming apparatus 2100 can immediately be started at the end of meeting.

### Fifth Embodiment

The image forming system in accordance with the present embodiment has the same configuration as image forming system 2050 in accordance with the fourth embodiment described above. In the present embodiment, however, the electronic blackboard apparatus transmits the activation signal in response to drawing of an image of a prescribed shape on the electronic blackboard apparatus by a hand-written input. In this point, the electronic blackboard apparatus in accordance with the present embodiment differs from electronic blackboard apparatus 2200 that transmits the activation signal in response to the touch operation of icons 2250 for marking.

In the present embodiment, when the user surrounds a name of a person in charge displayed on the electronic blackboard apparatus by a circle, or when the user draws an underline under a series of characters representing an action item or due date, by a drawing operation of hand writing, the electronic blackboard apparatus receives such a drawing operation and detects, from the difference between image data before and after the hand-written input, that an image of a circle or an underline has been drawn (that the marking operation has been done).

Detecting that the circle or the underline has been drawn by hand-written input, the electronic blackboard apparatus transmits the activation signal for switching image forming apparatus 2100 from the energy saving mode to the normal mode to image forming apparatus 2100.

When input is done by handwriting using a touch pen, the electronic blackboard apparatus directly detects the action of pen operation by the user (operator) and, therefore, it is possible to transmit the activation signal to image forming apparatus 2100 while the user is simply doing normal operations with a pen on the electronic blackboard apparatus.

In the present embodiment, if the image drawn by the drawing operation has a prescribed shape (circle, underline or the like), the electronic blackboard apparatus transmits the activation signal to image forming apparatus 2100. Since it is possible to transmit the activation signal to image forming apparatus 2100 by simply drawing an image of the prescribed shape, it is unnecessary for the user to do any special operation. Therefore, it is convenient for the user.

Meeting minutes basically have templates and, therefore, it is often the case that the person in charge is written on a fixed position. Therefore, by registering (setting) in advance the template of meeting minutes or the position where the person in charge is written, it becomes possible to easily specify the positions of person in charge, action item and due date. Therefore, it is possible to detect the prescribed marking operation when the name of a person in charge is surrounded by a circle, and to transmit the activation signal in response. Alternatively, when a name of any person, not limited to the person in charge, is surrounded by a circle, it may be detected as the prescribed marking operation.

### Sixth Embodiment

In the image forming system in accordance with the present embodiment, electronic blackboard apparatus 2300 recognizes voices of surrounding environment and if a prescribed time period passes without any voice recognized, it transmits the activation signal to image forming apparatus 2100. Assume that electronic blackboard apparatus 2300 is used for a meeting. It is common that the participants run out of topics near the end of a meeting. A demand of a voice by the chair person may be followed by a long silence. In the present embodiment, noting such a phenomenon, the activation signal is transmitted to image forming apparatus 2100 if a prescribed time period passes without any voice or utterance. Specifically, by detecting a state of silence continued for a prescribed time period, it is predicted that the meeting will end soon, and image forming apparatus 2100 is activated before starting printing of minutes and the like.

[Hardware Configuration]

<<Electronic Blackboard Apparatus 2300>>

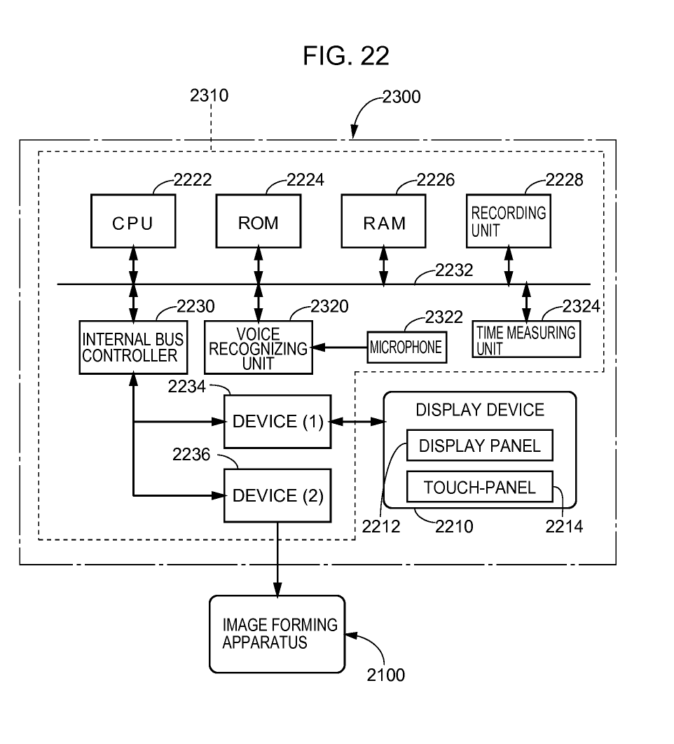

Referring to FIG. 22, electronic blackboard apparatus 2300 in accordance with the present embodiment has the same configuration as electronic blackboard apparatus 2200 in accordance with the fourth embodiment above. It is noted, however, that electronic blackboard apparatus 2300 in accordance with the present embodiment includes a control device 2310 in place of control device 2220 and, in this point, it is different from the fourth embodiment. Control device 2310 has the configuration of control device 2220 and additionally includes a voice recognizing unit 2320, a microphone 2322 and a time measuring unit 2324.

To voice recognizing unit 2320, voices around the electronic blackboard apparatus 2300 are input through microphone 2322. Voice recognizing unit 2320 detects whether any voice is input, and whether any voice of a volume large enough to be regarded as an utterance at the meeting is input, and thereby detects presence/absence of any utterance at the meeting or the like.

Time measuring unit 2324 is a timer, which is turned on using detection of absence of utterance by voice recognizing unit 2320 as a trigger. When an utterance is detected by voice recognizing unit 2320, time measurement stops, and time measuring unit 2324 is reset. When the measured time exceeds a prescribed time period, CPU 2222 transmits the activation signal to image forming apparatus 2100.

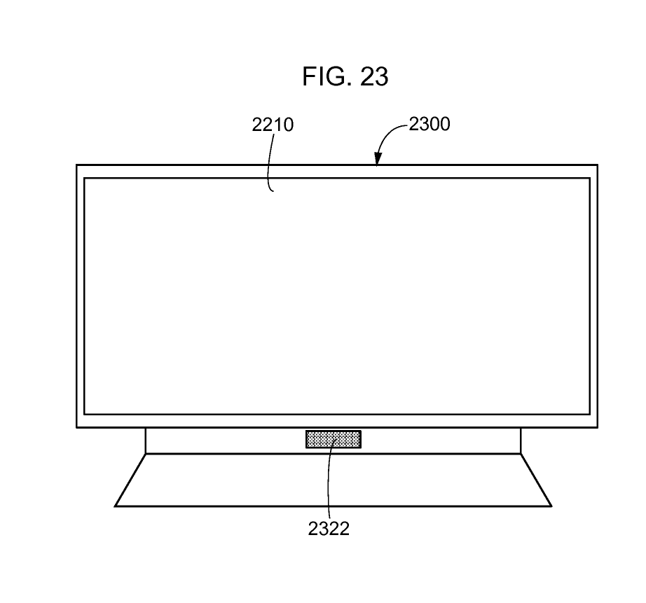

Referring to FIG. 23, microphone 2322 is mounted on a prescribed area on a front side of electronic blackboard apparatus 2300.

The configuration of image forming apparatus 2100 is the same as that of the fourth embodiment and, therefore, description thereof will not be repeated here.

[Software Configuration]

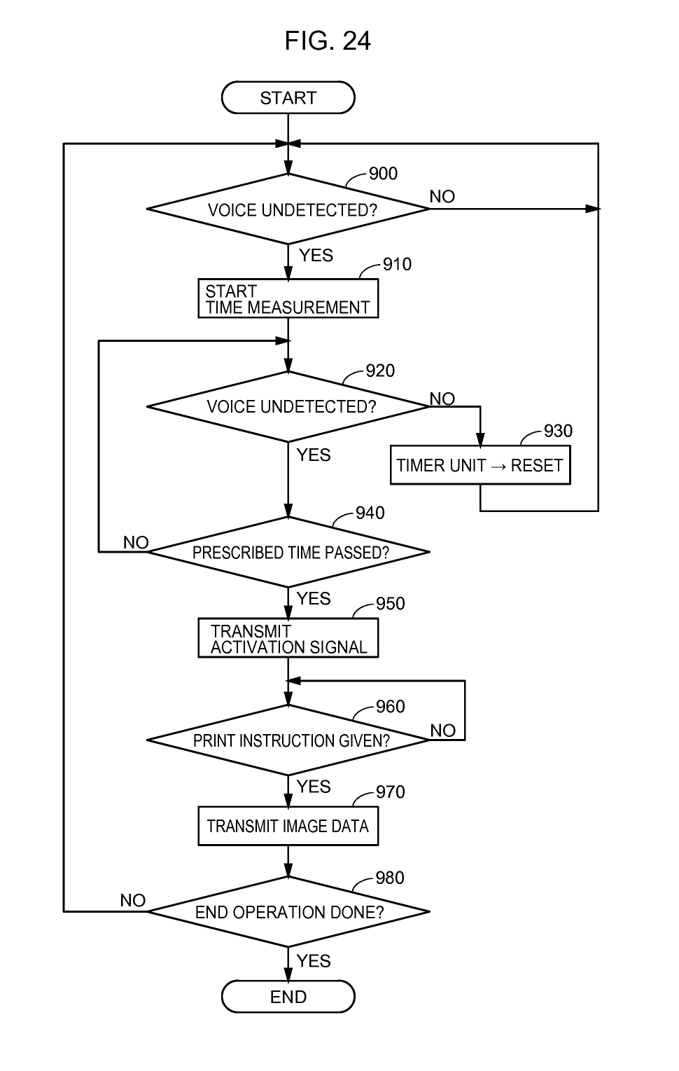

Referring to FIG. 24, the control structure of a computer program executed by electronic blackboard apparatus 2300 in the image forming system in accordance with the present embodiment will be described. The program is activated when application software having the printing function such as pen software is activated.

The program includes: a step 900 of detecting whether or not an utterance is detected, and waiting until utterance becomes too low to be detected; a step 910, executed if it is determined that utterance is undetected at step 900, of turning the timer on and starting time measurement; a step 920, executed after step 910, of determining whether or not an utterance is detected, and branching the flow of control depending on the result of determination; and a step 930, executed if it is determined at step 920 that an utterance is detected, of turning off the timer and resetting time measuring unit 2324, and returning the control flow to step 900.

The program further includes: a step 940, executed if it is determined at step 920 that utterance is undetected, of determining whether a prescribed time period has passed without detection of any utterance, and branching the flow of control depending on the result of determination; and a step 950, executed it is determined at step 940 that the prescribed time period has passed, of transmitting the activation signal for activating image forming apparatus 2100 to image forming apparatus 2100. If it is determined at step 940 that the prescribed time period without detection of utterance has not yet passed, the control returns to step 920.

The program further includes: a step 960, executed after step 950, of determining whether the user instructed printing, and waiting for the input of print instruction; a step 970, executed if it is determined at step 960 that a print instruction is input, of transmitting a command for executing printing and image data to image forming apparatus 2100; and a step 980, executed after step 970, of determining whether or not an end operation is done by the user, and branching the flow of control depending on the result of determination.

If it is determined at step 980 that an end operation is done by the user, the program ends. On the other hand, if it is determined that the end operation is not done by the user, the control returns to step 900.

[Operation]

The image forming system in accordance with the present embodiment operates in the following manner. In the following, of the operations of electronic blackboard apparatus 2300, only the portions related to the present invention will be described.

Assume that a meeting is held, where electronic blackboard apparatus 2300 is used. Towards the end of meeting, speeches and utterances decrease, and electronic blackboard apparatus 2300 comes to detect absence of utterance (YES at step 900). In the absence of utterance, electronic blackboard apparatus 2300 starts time measurement (step 910). If any utterance is detected (NO at step 920), time measurement is stopped and time measuring unit 2324 is reset (step 930). Then, in the absence of any utterance thereafter, electronic blackboard apparatus 2300 again starts time measurement (step 910).

When a prescribed time period passes without any utterance (YES at step 940), electronic blackboard apparatus 2300 transmits the activation signal to image forming apparatus 2100 (step 950). Receiving the activation signal transmitted from electronic blackboard apparatus 2300, image forming apparatus 2100 switches its mode from the energy saving mode to the normal mode. Specifically, it starts recovery to the normal mode. After receiving the activation signal, image forming apparatus 2100 returns to the normal mode after a prescribed time of warming-up (recovery from energy saving mode).

When speeches and statements run out, the meeting ends, and the minutes are printed by image forming apparatus 2100 to be handed out to the participants. When the user instructs printing to electronic blackboard apparatus 2300 (YES at step 960), electronic blackboard apparatus 2300 transmits the image data to image forming apparatus 2100 (step 970). Receiving the image data, image forming apparatus 2100 forms images based on the received image data, and executes the print process.

[Functions and Effects]

As is apparent from the foregoing description, use of the image forming system in accordance with the present embodiment attains the following effects.

Assuming that electronic blackboard apparatus 2300 is used for a meeting, it is common that the participants run out of topics near the end of the meeting. If a prescribed time period passes without any voice or utterance, electronic blackboard apparatus 2300 transmits the activation signal to image forming apparatus 2100. Thus, it becomes possible to predict the end of the meeting and to transmit in advance the activation signal to image forming apparatus 2100. Since image forming apparatus 2100 has already been activated by the end time of the meeting, printing by image forming apparatus 2100 can immediately be started at the end of the meeting.

### Seventh Embodiment

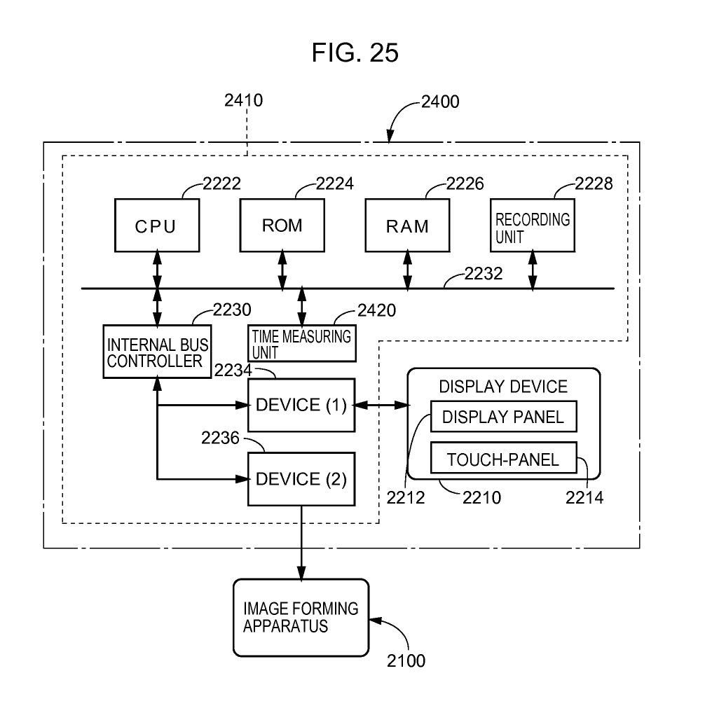

Referring to FIG. 25, the image forming system in accordance with the present embodiment includes an electronic blackboard apparatus 2400 in place of electronic blackboard apparatus 2200 in accordance with the fourth embodiment. In the image forming system in accordance with the present embodiment, if a prescribed time period passes without any action to electronic blackboard apparatus 2400, electronic blackboard apparatus 2400 transmits the activation signal to image forming apparatus 2100.

Assuming that electronic blackboard apparatus 2400 is used for a meeting, it is sometimes the case that the chair person asks each of the participants for questions and comments. In such a situation, no action is done on electronic blackboard apparatus 2400. In the present embodiment, noting such a phenomenon, the activation signal is transmitted to image forming apparatus 2100 if a prescribed time period passes without any action to electronic blackboard apparatus 2400. Specifically, by detecting a state of inaction to electronic blackboard apparatus 2400 continued for a prescribed time period, it is predicted that the meeting will end soon, and image forming apparatus 2100 is activated before starting printing of minutes and the like.

[Hardware Configuration]

<<Electronic Blackboard Apparatus 2400>>

Referring to FIG. 25, electronic blackboard apparatus 2400 in accordance with the present embodiment has the same configuration as electronic blackboard apparatus 2200 in accordance with the fourth embodiment above. It is noted, however, that electronic blackboard apparatus 2400 in accordance with the present embodiment includes a control device 2410 in place of control device 2220 and, in this point, it is different from the fourth embodiment. Control device 2410 has the configuration of control device 2220 and additionally includes a time measuring unit 2420.

Time measuring unit 2420 is a timer, which is turned on using detection of absence of any action to electronic blackboard apparatus 2400 as a trigger. When any action to electronic blackboard apparatus 2400 is detected, time measurement stops, and time measuring unit 2420 is reset. When the measured time exceeds a prescribed time period, CPU 2222 transmits the activation signal to image forming apparatus 2100. The configuration of image forming apparatus 2100 is the same as that of the fourth embodiment and, therefore, description thereof will not be repeated here.

As described above, by transmitting the activation signal if the state of inaction to electronic blackboard apparatus 2400 continues for a prescribed time period, it is possible to predict the end of meeting and to transmit in advance the activation signal to image forming apparatus 2100.

(Modifications)

Though examples in which the present invention is applied to electronic blackboards as an example of image forming apparatus have been described in the fourth to seventh embodiments above, the present invention is not limited to such embodiments. The present invention is applicable to image display devices other than the electronic blackboard apparatuses provided that the image display device allows touch operations such as the marking operation.

Though examples in which a multifunctional peripheral is used as the image forming apparatus connected to the electronic blackboard apparatus have been described in the fourth to seventh embodiments above, the present invention is not limited to such embodiments. Any image forming apparatus having the function of printing other than the multifunctional peripheral may be used as the image forming apparatus connected to the electronic blackboard apparatus.

Though examples in which a touch pen is used for the touch operation (including the marking operation and the drawing operation) to the electronic blackboard apparatus have been described in the fourth to seventh embodiments above, the present invention is not limited to such embodiments. The touch operation to the electronic blackboard apparatus may be done using a member other than the touch pen. By way of example, a touch operation by one's finger is also possible.

Though examples in which the activation signal is transmitted to the image forming apparatus when a prescribed touch operation is detected during preparation of minutes and the like have been described in the fourth and fifth embodiments above, the present invention is not limited to such embodiments. Other than at the time of preparing minutes, the activation signal may be transmitted to the image forming apparatus when writing is done on the electronic blackboard during a lecture, or when a prescribed touch operation is detected during a presentation.

Though an example in which the activation signal is transmitted to the image forming apparatus when a touch of a marking icon is detected has been described in the fourth embodiment above, the present invention is not limited to such an embodiment. By way of example, the activation signal may be transmitted to the image forming apparatus when it is detected that any of the marking icons is touched and thereafter a person in charge is surrounded by a circle or a series of characters is underlined.

In the sixth embodiment, an example in which the activation signal is transmitted to the image forming apparatus if a state with no utterance continued for a prescribed time period is detected. Here, it is possible to record voices of a chair person, and if it is recognized by the voice recognizing unit that no utterance is made for a prescribed time period after the voice of the chair person, to transmit the activation signal to the image forming apparatus.

Embodiments realized by appropriately combining the techniques disclosed above are also encompassed by the technical scope of the present invention.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention can provide an image forming apparatus in which the wait time for the user, experienced when printing is to be done from the energy saving state, can be reduced. Further, the present invention provides a control device, an image forming apparatus and an image forming system that can reduce the wait time the user is kept waiting until printing is done, using an image forming apparatus that is switched to the energy saving state. Further, the present invention provides an image display device and an image forming system that can effectively reduce the time period for the user experienced when the image forming apparatus returns to the normal state.

### REFERENCE SIGNS LIST

100 input device
120, 328, 2180 touch-panel display
180, 300, 1100, 2100 image forming apparatus
182, 310, 2110, 222 CPU
190 LAN environment
260 area near icons
270 specific area
1050 print system
1200, 1500 image display device
1300, 1600 information processing apparatus
1570 camera
1580, 2322 microphone
2050 image forming system
2170 communication unit
2200, 2300, 2400 electronic blackboard apparatus
2210 display device
2220 control device
2250, 2250a, 2250b, 2250c icons
2320 voice recognizing unit
2324, 2420 time measuring unit

1. An input device having a processor, connected to a display device and to an image forming apparatus set in advance to stop power supply to various units forming the image forming apparatus if an instruction to form an image is not received for a prescribed time period, said input device comprising:
said processor configured to receive an input of an operation instruction to an image displayed on said display device; wherein
said operation instruction is
a first operation instruction for operating an area including a function icon for editing said image, displayed on said display device,
a second operation instruction for operating a prescribed area of said image, or
a third operation instruction for switching a page of said image;
said input device further comprising
said processor, responsive to the reception of any of said first to third operation instructions, configured to execute an activation control application to transmit, to said image forming apparatus, an activation signal to start power supply to each of said units.

2. The input device according to claim 1, formed as a touch-panel integrated with said display device.

3. An image forming apparatus, having a processor, set in advance to stop power supply to various units forming the image forming apparatus if an instruction to form an image is not received for a prescribed time period, comprising:
a display device; and
said processor configured to receive an input of an operation instruction to an image displayed on said display device; wherein
said operation instruction is
a first operation instruction for operating an area including a function icon for editing said image, displayed on said display device,
a second operation instruction for operating a prescribed area of said image, or
a third operation instruction for switching a page of said image;
said image forming apparatus further comprising
said processor, responsive to the reception of any of said first to third operation instructions, configured to execute an activation control application to transmit, to said image forming apparatus, an activation signal to start power supply to each of said units.

4. A method of executing an application executed in an input device, having a processor, connected to a display device and to an image forming apparatus set in advance to stop power supply to various units forming the image forming apparatus if an instruction to form an image is not received for a prescribed time period, said input device comprising
said processor configured to receive an input of an operation instruction to an image displayed on said display device; wherein
said operation instruction is
a first operation instruction for operating an area including a function icon for editing said image, displayed on said display device,
a second operation instruction for operating a prescribed area of said image, or
a third operation instruction for switching a page of said image;
said method comprising the step of
transmitting, in response to the reception of any of said first to third operation instructions, an activation signal to start power supply to each of said units, to said image forming apparatus.

5. A control device, connected to an image forming apparatus, for controlling state of power conduction of said image forming apparatus; wherein
said image forming apparatus is automatically switched from a normal power conduction state to a power saving state of smaller power consumption if an instruction for forming an image is not received for a prescribed time period, and makes a transition to said normal power conduction state if an activation signal for recovery is received in said power saving state; and
said image forming apparatus is not capable of forming an image in said power saving state, and at least a certain time period is necessary for said image forming apparatus to recover from said power saving state to said normal power conduction state;
said control device, having a processor, in which:
said processor performs schedule management for managing a schedule of a user;
a time measuring device measures a time; and
said processor is configured to transmit said activation signal to said image forming apparatus, when the time measured by said time measuring device reaches a prescribed time set by the schedule.

6. The control device according to claim 5, wherein said schedule management performed by said processor manages an end time of a meeting in which said user participates; and
said processor further configured to transmit said activation signal to said image forming apparatus, when the time measured by said time measuring device reaches a time satisfying a prescribed relation with the end time of the meeting managed by said processor.

7. The control device according to claim 6, wherein said processor further configured to transmit activation signal to said image forming apparatus, when the time measured by said time measuring device reaches a time earlier than the end time of the meeting managed by said processor by a prescribed time period longer than said certain time period.

8. The control device according to claim 5, wherein said processor further configured to start a process for repeatedly transmitting said activation signal to said image forming apparatus at a constant interval, when the time measured by said time measuring device reaches a time satisfying a prescribed relation with the end time of the meeting managed by said processor.

9. The control device according to claim 5, wherein said
processor further configured to collectively manage schedules of a plurality of users; and
said processor further configured to transmit said activation signal to said image forming apparatus, when the time measured by said time measuring device reaches a prescribed time set by a schedule managed by said processor.

10. An image display device, including a processor, connected to an image forming apparatus capable of switching operations between a normal power conduction state and an energy saving state with reduced power consumption, comprising:
a display operation device for receiving a touch operation and displaying an image;
said processor, responsive to said display operation device receiving a prescribed marking operation as said touch operation, for transmitting an activation signal for switching said image forming apparatus from the energy saving state to the normal power conduction state, to said image forming apparatus; and
said processor configured to transmit image data of an image displayed on said display operation device to said image forming apparatus.

11. The image display device according to claim 10, wherein
said processor configured to display an icon for pasting a drawn image of a prescribed shape on said display operation device;
said display operation device configured to receive a marking operation of touching said icon and for displaying an image corresponding to the icon; and
said processor further, responsive to said display operation device receiving said operation of touching said icon, configured to transmit the activation signal for switching said image forming apparatus from the energy saving state to the normal power conduction state, to said image forming apparatus.

12. The image display device according to claim 10, wherein
said touch operation is a drawing operation for displaying a drawn image;
said image display device further comprising
said processor configured to detect, based on a difference between image data before and after the drawn image is displayed, whether the drawn image has a prescribed shape; and wherein
said processor, responsive to said display operation device receiving, as said prescribed marking operation, an operation of drawing an image having the prescribed shape, based on a result of detection by said detecting, configured to transmit the activation signal for switching said image forming apparatus from the energy saving state to the normal power conduction state, to said image forming apparatus.

13. An image display device, having a processor, connected to an image forming apparatus capable of switching operations between a normal power conduction state and an energy saving state with reduced power consumption, comprising:
a display device displaying an image;
a voice recognizing device configured to recognize a voice around said image display device while said display device is displaying an image;
a time measuring device for measuring a time period in which no voice is recognized by said voice recognizing device;
said processor configured to transmit an activation signal for switching said image forming apparatus from the energy saving state to the normal power conduction state to said image forming apparatus, when a prescribed time period passed without recognizing any voice; and
said processor configured to transmit image data of the image displayed on said display device to said image forming apparatus.

14. An image forming system including an image forming apparatus capable of switching operations between a normal power conduction state and an energy saving state with reduced power consumption, and an image display device connected to said image forming apparatus; wherein
said image display device, having an image display device processor, includes
a display operation means receiving a touch operation and displaying an image,
said image display device processor, responsive to said display operation device receiving a prescribed marking operation as said touch operation, configured to transmit an activation signal for switching said image forming apparatus from the energy saving state to the normal power conduction state, to said image forming apparatus, and
said image display device processor configured to transmit image data of an image displayed on said display operation device to said image forming apparatus; and
said image forming apparatus, having an image forming processor,
said image forming processor configured to receive the activation signal and switching operation to the energy saving state, and
said image forming processor configured to receive the image data and for forming an image based on the image data.
